(19) United States
(12) Patent Application Publication
(10) Pub. No.: US 2025/0141518 A1
(43) Pub. Date: May 1, 2025

(54) MODEL TRAINING METHODS AND APPARATUSES, SAMPLE DATA GENERATION METHOD AND APPARATUS, AND ELECTRONIC DEVICE

(71) Applicant: GUANGDONG OPPO MOBILE TELECOMMUNICATIONS CORP., LTD., Dongguan (CN)

(72) Inventor: Han XIAO, Dongguan (CN)

(21) Appl. No.: 19/003,397

(22) Filed: Dec. 27, 2024

Related U.S. Application Data
(63) Continuation of application No. PCT/CN2022/104111, filed on Jul. 6, 2022.

(51) Int. Cl. H04B 7/06

(52) U.S. Cl. CPC H04B 7/0626; H04B 7/0634; H04B 7/0639

(57) ABSTRACT

Provided in embodiments of the application are model training methods and apparatuses. A model training method includes: a first device generating a plurality of pieces of sample data on the basis of a first codebook of a precoding matrix; the first device training an initial channel state information (CSI) feedback model on the basis of the plurality of pieces of sample data to obtain a CSI feedback meta-model. The CSI feedback meta-model is used for training a target CSI feedback model, and the target CSI feedback model is used for encoding CSI obtained by a signal receiving end and restore the encoded CSI at a signal transmitting end. Further provided in the embodiments of the application are a sample data generation method and apparatus.

### CROSS-REFERENCE TO RELATED APPLICATION

This is a continuation application of International Patent Application No. PCT/CN2022/104111, filed on Jul. 6, 2022, the content of which is hereby incorporated by reference in its entirety.

### BACKGROUND

At present, in a design for channel state information (CSI) feedback in a new radio (NR) system of the 5th generation (5G) mobile communication technology, extraction and feedback of a channel feature are mainly implemented by using a codebook-based feedback scheme. However, such scheme only involves selecting an optimal feature value vector of channel information from a codebook according to a channel estimation result. The mapping process from the channel estimation result to the channel information in the codebook is lossy, thereby reducing the accuracy of the CSI that is fed back, and further reducing the precoding performance.

CSI feedback based on artificial intelligence (AI) considers that CSI is compressed by using an encoder in an AI model at a transmitting end, and the CSI is reconstructed by using a decoder in the AI model at a receiving end. The AI-based scheme utilizes a non-linear fitting capability of a neural network to compress and feed the CSI back, thereby greatly improving compression efficiency and feedback accuracy. However, due to the increasing complexity of the current radio frequency environment, channels of different cells have different potential features. The inherent disadvantage of a generalization problem of the neural network in practical applications causes that a trained network is applicable only to a channel test set having the same features as channel data of a training set. That is, it is often difficult for the training set to cover all cases. Thus, it is also difficult for the trained AI model to continue to maintain good generalization performance in a case that the scenario feature changes.

In a class of methods based on meta learning, a trained meta model can be used to perform retraining in a target scenario according to less data of the target scenario, to achieve fast adaptation to the target scenario. However, a premise of implementation of such scheme is that a huge amount of sample data of different scenarios is required to support construction of the meta model. In terms of actual acquisition costs and acquisition difficulties, it is challenging to acquire the huge amount of CSI with high diversity.

### SUMMARY

Embodiments of the present disclosure relate to the technical field of mobile communications, and in particular to a method for training a model and an electronic device.

According to an embodiment of the present disclosure, a method for training a model is provided, and the method includes the following operations.

A first device generates a plurality of pieces of sample data based on a first codebook of a precoding matrix.

The first device trains an initial channel state information (CSI) feedback model based on the plurality of pieces of sample data to acquire a CSI feedback meta model. Herein, the CSI feedback meta model is used to train a target CSI feedback model, and the target CSI feedback model is used to encode channel state information acquired by a signal receiving end, and recover the encoded channel state information at a signal transmitting end.

According to an embodiment of the present disclosure, an electronic device is provided, which may be the first device in the aforementioned scheme. The electronic device includes a processor and a memory. The processor is configured to generate a plurality of pieces of sample data based on a first codebook of a precoding matrix; and train an initial channel state information (CSI) feedback model based on the plurality of pieces of sample data to acquire a CSI feedback meta model. Herein, the CSI feedback meta model is used to train a target CSI feedback model, and the target CSI feedback model is used to encode channel state information acquired by a signal receiving end, and recover the encoded channel state information at a signal transmitting end.

In the method for training the model according to the embodiments of the present application, the first device may generate the plurality of pieces of sample data based on the first codebook of the precoding matrix. Further, the first device may train the initial CSI feedback model based on the plurality of pieces of sample data that are generated, to acquire the CSI feedback meta model. The CSI feedback meta model is used to train the target CSI feedback model, and the CSI feedback model is used to encode channel state information acquired by the signal receiving end, and recover the encoded channel state information at the signal transmitting end. It can be seen that, considering that the precoding codebook can reflect actual channel state information to some extent, the sample data for training the CSI feedback meta model in the present disclosure may be generated according to the first codebook of the precoding matrix. Thus, there is no need to acquire the huge amount of CSI which is acquired via the channel estimation, thereby greatly reducing the difficulty and labor overhead of the sample data acquisition.

### BRIEF DESCRIPTION OF THE DRAWINGS

The accompanying drawings constituting a part of the present disclosure provide further understanding of the present disclosure. The schematic embodiments of the present disclosure and the description thereof are intended to be illustrative of the present disclosure, and do not constitute an undue limitation to the present disclosure. In the accompanying drawings:

FIG. 1 is a schematic diagram of a communication flow of a wireless communication system according to an embodiment of the present disclosure.

FIG. 2 is a schematic structural diagram of a neuron according to the related art.

FIG. 3 is a schematic structural diagram of a neural network according to the related art.

FIG. 4 is a schematic structural diagram of a convolutional neural network according to the related art.

FIG. 5 is a schematic structural diagram of a long short-term memory network (LSTM) according to the related art.

FIG. 6 is a schematic diagram of a processing flow of an autoencoder according to the related art.

FIG. 7 is a schematic structural diagram of an AI-based CSI feedback model according to the related art.

FIG. 8 is a first schematic flowchart of a method for training a model according to an embodiment of the present disclosure.

FIG. 9 is a second schematic flowchart of a method for training a model according to an embodiment of the present disclosure.

FIG. 10 is a third schematic flowchart of a method for training a model according to an embodiment of the present disclosure.

FIG. 11 is a schematic composition diagram of a first vector set according to an embodiment of the present disclosure.

FIG. 12 is a schematic diagram of a training process of a CSI meta model according to an embodiment of the present disclosure.

FIG. 13 is a fourth schematic flowchart of a method for training a model according to an embodiment of the present disclosure.

FIG. 14 is a schematic diagram of an online training and deployment method according to an embodiment of the present disclosure.

FIG. 15 is a schematic flowchart of a method for generating sample data according to an embodiment of the present disclosure.

FIG. 16 is a fifth schematic flowchart of a method for training a model according to an embodiment of the present disclosure.

FIG. 17 is a schematic structural composition diagram of an apparatus 1700 for training a model according to an embodiment of the present disclosure;

FIG. 18 is a schematic structural composition diagram of an apparatus 1800 for generating sample data according to an embodiment of the present disclosure.

FIG. 19 is a schematic structural composition diagram of an apparatus 1900 for training a model according to an embodiment of the present disclosure.

FIG. 20 is a schematic structural diagram of an electronic device according to an embodiment of the present disclosure.

FIG. 21 is a schematic structural diagram of a chip according to an embodiment of the present disclosure.

### DETAILED DESCRIPTION

The technical schemes in the embodiments of the present disclosure are described below with reference to the drawings in the embodiments of the present disclosure. It is apparent that the described embodiments are partial embodiments of the present disclosure but not all embodiments. Based on the embodiments in the present disclosure, all other embodiments acquired by those of ordinary skill in the art without creative work shall fall within the scope of protection of the present disclosure.

To facilitate the understanding of the technical schemes of the embodiments of the present disclosure, the following related technologies of the embodiments of the present disclosure are described below. The following related technologies can be arbitrarily combined with the technical schemes of the embodiments of the present disclosure as optional solutions, all of which fall within the scope of protection of the embodiments of the present disclosure.

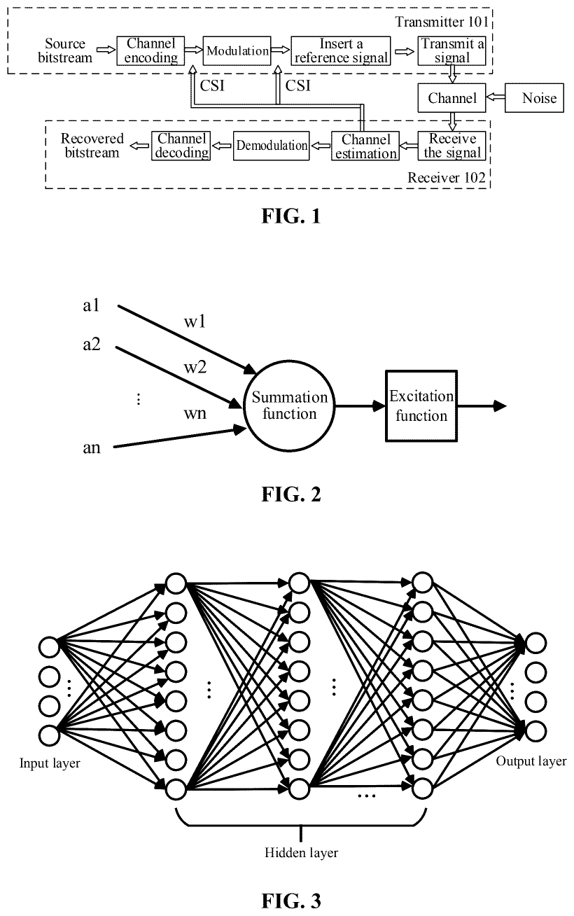

FIG. 1 is a schematic diagram of a communication flow of a wireless communication system according to an embodiment of the present disclosure. As shown in FIG. 1, the wireless communication system may include a transmitting end and a receiving end.

At the signal transmitting end, a transmitter 101 performs channel encoding and modulation on a source bitstream to acquire modulated data. A reference signal (e.g., a channel state information reference signal (CSI-RS)) is inserted into the modulated data, and the inserted reference signal is used for channel estimation at the signal receiving end. Finally, a signal to be transmitted is formed, and further arrives at the receiving end through a channel. The signal to be transmitted is subjected to interference of noise while being transmitted to the receiving end through the channel.

At the signal receiving end, a receiver 102 firstly receives the signal transmitted by the signal transmitting end and further acquires a received signal; and then, performs channel estimation by using the reference signal in the received signal, to acquire channel state information (CSI). The signal receiving end feeds the CSI back to the signal transmitting end through a feedback link, to enable the transmitter to adjust manners of channel encoding, modulation, precoding, and the like. Finally, the receiver performs operations of demodulating, channel decoding, and the like on the received signal, and acquires a final recovered bitstream.

It should be noted that FIG. 1 is a simplified schematic diagram of the communication flow of the wireless communication system. The wireless communication system further includes other modules that are not illustrated, such as a resource mapping module, a precoding module, an interference cancellation module, and a CSI measurement module, etc. Such modules are also designed and implemented individually, and then the independent modules may be integrated to form a complete wireless communication system.

It should be further noted that the aforementioned wireless communication system may be a long term evolution (LTE) system, a LTE time division duplex (TDD) system, a universal mobile telecommunication system (UMTS) system, an Internet of Things (IoT) system, a narrow band Internet of Things (NB-IoT) system, an enhanced machine-type communications (eMTC) system, a 5G NR system, a future communication system (e.g., a 6G communication system), or the like.

In an embodiment, the signal transmitting end may be a network device or a terminal device, and the signal receiving end may also be a network device or a terminal device. Exemplarily, when the signal transmitting end is the network device, the signal receiving end may be the terminal device. When the signal transmitting end is the terminal device, the signal receiving end may be the network device. When the signal transmitting end is the terminal device, the signal receiving end may also be the terminal device, thereby implementing device-to-device communication.

In an embodiment, the network device may be an evolutional base station (evolutional node B, eNB or eNodeB) in an LTE system, a next generation radio access network (NG RAN) device, a base station (gNB) in an NR system, or a wireless controller in a cloud radio access network (CRAN). The network device may further be a relay station, an access point, a vehicle-mounted device, a wearable device, a hub, a switch, a network bridge, a router, an access network device in a future evolutional public land mobile network (PLMN), or the like.

The terminal device may be any terminal device, which includes, but is not limited to, an access terminal, user equipment (UE), a user unit, a user station, a mobile station, a mobile platform, a remote station, a remote terminal, a mobile device, a user terminal, a terminal, a wireless communication device, a user agent, or a user apparatus. The access terminal may be a cellular phone, a cordless phone, a session initiation protocol (SIP) phone, an IoT device, a satellite handheld terminal, a wireless local loop (WLL) station, a personal digital assistant (PDA), a handheld device with a wireless communication function, a computing device, another processing device connected to a wireless modem, a vehicle-mounted device, a wearable device, a terminal device in a 5G network, a terminal device in a future evolutional network, or the like.

In the current CSI feedback design, extraction and feedback of a channel feature are mainly implemented by utilizing a codebook-based scheme. Specifically, after performing the channel estimation, the signal receiving end selects, according to a certain optimization criterion, a precoding matrix that best matches a channel estimation result from a preset codebook. Additionally, the signal receiving end further feeds information such as an index of the precoding matrix back to the signal transmitting end through a feedback link of an air interface. Therefore, the precoding is implemented at the signal transmitting end. In an embodiment, the codebook may be classified into a type 1 (TypeI) codebook, a type 2 (TypeII) codebook, and an enhanced type 2 (eTypeII) codebook.

The eTypeII codebook is used as an example to describe a specific method for the CSI feedback. The precoding matrix to be fed back may be denoted as W∈C^{Nt×Nsb}, where C represents a complex number space, Nt represents the number of transmission antenna ports, and Nsb represents the number of subbands. It can be understood that the matrix W is a matrix of Nt×Nsb in the complex number space C. Here, each column of the matrix W represents a precoding vector shared by a plurality of subcarriers on each subband.

For the eTypeII codebook, it is firstly considered that the W is compressed as W′=W₁W₂W_{f}. A diagonal block matrix W₁=[B, 0; 0, B]∈C^{Nt×2L}. All columns in B∈C^{Nt/2×L} are a group of L orthogonal base vectors selected from a discrete Fourier transform (DFT) vector space of the eTypeII codebook. In addition, all rows in W_{f}∈C^{M×Nsb} are also a group of M orthogonal base vectors selected from the DFT vector space. W₂∈C^{2L×M} is projection coefficients on the two groups of base vectors of the precoding matrix W.

In practical applications, when the eTypeII codebook is used at the signal receiving end, the following information may be fed back to the receiving end through the feedback link according to the channel estimation result:
a. indexes of the L base vectors that are selected from the DFT vector space to form the orthogonal base matrix B;
b. indexes of the M base vectors that are selected from the DFT vector space to form the orthogonal base matrix W_{f}; and
c. coefficients from the projection coefficient matrix W₂.

Correspondingly, upon receiving the above information through the feedback link, the signal transmitting end may recover, according to the above information, the precoding matrix by using the codebook structure W′=W₁W₂W_{f} of the e TypeII codebook.

Construction of the DFT vector space and the selection process of the orthogonal base matrix are described below.

Description is provided by taking an example at which an antenna of the signal transmitting end is a two-dimensional planar array antenna. At the signal transmitting end, the number of antenna ports in a first dimension (e.g., a horizontal direction) is N₁, and the number of antenna ports in a second dimension (e.g., a vertical direction) is N₂. In consideration of dual polarization, the total number of antenna ports is Nt=2N₁N₂. Accordingly, in the eTypeII codebook, the DFT vector space corresponding to W₁ may include at most Nt orthogonal DFT vectors having a length of Nt. Each DFT vector may be represented by the following equation (1-1):

$${b}_{m , n} = {c}_{m} ⊗ {p}_{n} \qquad ( 1 - 1 )$$

where m is an arbitrary integer within [0, N₁], and n is an arbitrary integer within [0, N₂]. cₘ and pₙ are respectively the DFT vectors in the first dimension and the second dimension. ⊗ represents a Kronecker product.

Specifically, cₘ may be determined via the following equation (1-2):

$${c}_{m} = {[ 1 , ⋯ , exp ( j 2 π ( x - 1 ) m ) / {N}_{1} , ⋯ , exp ( j 2 π ( {N}_{1} - 1 ) m ) / {N}_{1} ]}^{T} \qquad ( 1 - 2 )$$

where the length of cₘ is N₁, and the value of x ranges from 2 to N₁−1.

In addition, pₙ may be determined via the following equation (1-3):

$${p}_{n} = {[ 1 , ⋯ , exp ( j 2 π ( y - 1 ) n ) / {N}_{2} , ⋯ , exp ( j 2 π ( {N}_{2} - 1 ) n ) / {N}_{2} ]}^{T} \qquad ( 1 - 3 )$$

where the length of pₙ is N₂, and the value of y ranges from 2 to N₂−1.

In the embodiments of the present disclosure, any two b_{m, n} in the DFT vector space corresponding to the eTypeII codebook are orthogonal to each other.

In practical applications, in order to improve quantization precision of the codebook and increase the number of base vectors in the DFT vector space, oversampled two-dimensional DFT vectors are typically used. Assuming that the oversampling factor in the first dimension of the oversampling factor of is O₁ and the oversampling factor in the second dimension of the two-dimensional array antenna is O₂, there may be totally O₁O₂ DFT vector groups which are similar to the above b_{m, n} having Nt orthogonal DFT vectors. The total number of DFT vectors included in the oversampled DFT vector space may be increased to N₁O₁N₂O₂, which may be represented by equation (1-4):

$${a}_{m , n} = {v}_{m} ⊗ {u}_{n} \qquad ( 1 - 4 )$$

In equation (1-4), m is an arbitrary integer within [0, N₁O₁], and n is an arbitrary integer within [0, N₂O₂]. vₘ and uₙ are respectively the oversampled DFT vectors in the first dimension and the second dimension.

vₘ may be determined via the following equation (1-5):

$${v}_{m} = {[ 1 , ⋯ , exp ( j 2 π ( x - 1 ) m ) / {N}_{1} {O}_{1} , ⋯ , exp ( j 2 π ( {N}_{1} - 1 ) m ) / {N}_{1} {O}_{1} ]}^{T} \qquad ( 1 - 5 )$$

where the length of vₘ is N₁O₁, and the value of x ranges from 2 to N₁−1.

uₙ may be determined via the following equation (1-6):

$${u}_{n} = {[ 1 , ⋯ , exp ( j 2 π ( y - 1 ) n ) / {N}_{2} {O}_{2} , ⋯ , exp ( j 2 π ( {N}_{2} - 1 ) n ) / {N}_{2} {O}_{2} ]}^{T} \qquad ( 1 - 6 )$$

where the length of uₙ is N₂, and the value of y ranges from 2 to N₂−1.

It should be understood that, after the construction of the DFT vector space corresponding to W₁ in the eTypeII codebook is completed, a vector group may be selected from the O₁O₂ orthogonal vector groups. Then, L orthogonal base vectors may be selected from the vector group to form each column of the matrix B, thereby acquiring the matrix W₁ in the eTypeII codebook.

In addition, the construction method for the DFT vector space corresponding to W_{f} in the eTypeII codebook is similar to the construction method for the DFT vector space corresponding to W₁. Each DFT vector in the DFT vector space corresponding to W_{f} may be determined via the following equation (1-7):

$$( 1 - 7 )$$

$${q}_{m} = {[ 1 , … , exp ( j 2 π ( 𝓏 - 1 ) m ) / Nsb , … , exp ( j 2 π ( Nsb - 1 ) m ) / Nsb ]}^{T}$$

where the length of qₘ is Nsb, and the value of z ranges from 2 to Nsb−1. The DFT vector space corresponding to W_{f} includes Nsb orthogonal base vectors having the length of Nsb.

It should be understood that, after the construction of the DFT vector space corresponding to W_{f} in the eTypeII codebook is completed, M base vectors may be selected from the vector space to form each row of the matrix W_{f}.

In recent years, artificial intelligence research represented by neural networks has made great achievements in many fields, and will still play an important role in production and life of people for a very long time in the future. A neural network is a computational model formed by connecting a plurality of neuron nodes to each other, referring to a schematic diagram of a neuron structure shown in FIG. 2. As shown in FIG. 2, the neuron structure may be connected to other neuron structures a1 to an. Signal transmission between the neuron structures may be affected by weights (for example, a weight value of a signal input by the neuron structure a1 is w1), and each neuron structure may perform a weighted summation of multiple input signals and provide an output via a specific activation function.

FIG. 3 is a schematic structural diagram of a neural network according to the related art. As shown in FIG. 3, the structure of the neural network may include: an input layer, a hidden layer, and an output layer. As shown in FIG. 3, the input layer is responsible for receiving data, the hidden layer processes the data, and a final result is generated at the output layer. Herein, each node represents a processing unit, which may be regarded as a simulation of a neuron. Multiple neurons form a layer of the neural network, and multiple layers of information transfer and processing construct an overall neural network.

With the continuous development of researches on neural networks, a deep learning algorithm for the neural network has been proposed in recent years, and more hidden layers are introduced. Feature learning is carried out by layer-by-layer training of the neural network with multiple hidden layers, which greatly improves learning and processing capabilities of the neural network. The neural network is widely used in pattern recognition, signal processing, optimization combination, abnormality detection, and the like.

Also, with the development of deep learning, convolutional neural networks (CNNs) have been further studied.

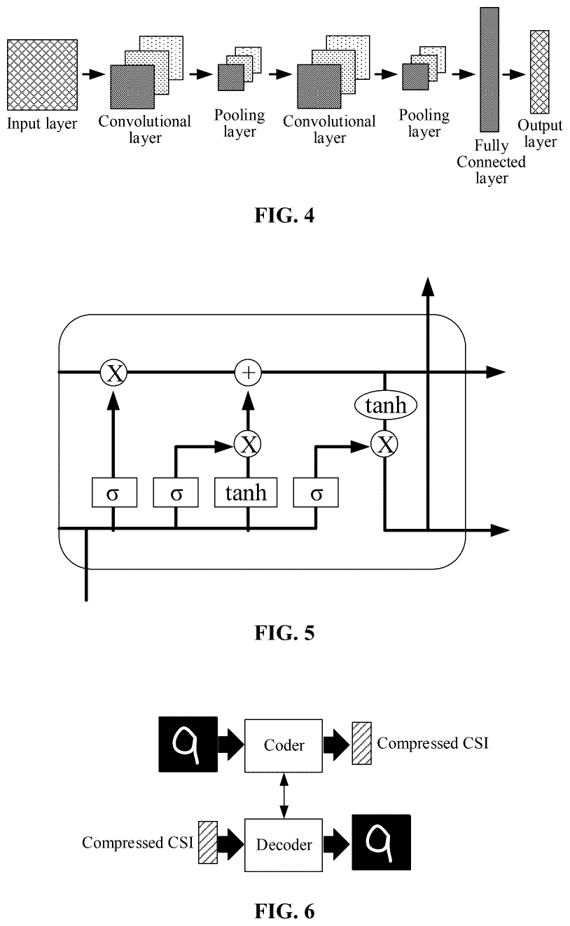

FIG. 4 is a schematic structural diagram of a convolutional neural network according to the related art. As shown in FIG. 4, the structure of the convolutional neural network may include: an input layer, multiple convolutional layers, multiple pooling layers, a fully connected layer, and an output layer. The introduction of the convolutional layers and the pooling layers effectively controls a sharp increase of network parameters, limits the number of parameters and exploits characteristics of local structures, thereby improving robustness of the algorithm.

Recurrent neural networks have made significant achievements in the field of natural language processing, such as machine translation, speech recognition, etc. A recurrent neural network is a neural network that is used for modeling sequential data, memorizes information of a past time moment, and further uses such information in computation of a current output. That is, nodes between hidden layers are no longer non-connected but connected, and an input of a hidden layer includes not only an output of the input layer but also an output of a hidden layer of a previous time moment.

FIG. 5 is a schematic structural diagram of a long short-term memory network (LSTM) according to the related art. The LSTM is a common recurrent neural network. Unlike the recurrent neural network that considers only the latest state, the LSTM determines which states should be kept and which states should be forgotten. Thus, defects of the conventional recurrent neural network in the long-term memory can be solved.

In practical applications, the CSI feedback may be implemented by applying an AI technology. Specifically, the feature extraction and compression may be performed on the estimated CSI at the signal receiving end by applying the AI technology, and the CSI compressed and fed back at the signal receiving end is recovered as much as possible at the signal transmitting end, thereby providing the possibility of reducing the CSI feedback overhead while ensuring the recovery of the CSI.

FIG. 6 is a schematic diagram of a processing flow of an autoencoder according to the related art. In the AI-based CSI feedback, the CSI to be fed back may be regarded as an image to be compressed. The CSI is compressed and fed back by using a deep learning autoencoder, and the compressed CSI is reconstructed at the signal transmitting end, so as to retain the original CSI information to a greater extent.

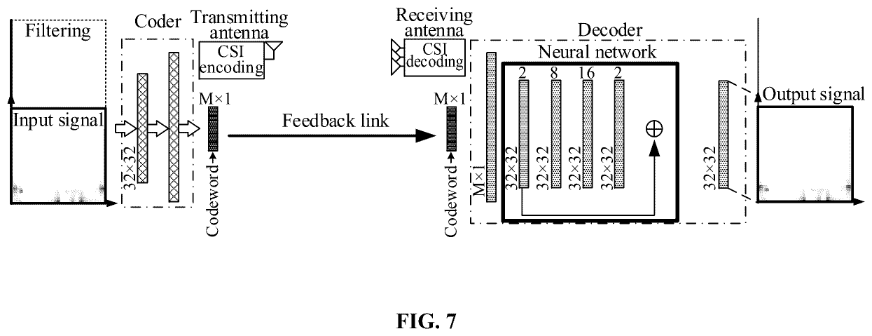

FIG. 7 shows a schematic structural diagram of an exemplary AI-based CSI feedback model. The entire CSI feedback model may be divided into an encoder and a decoder, which are respectively deployed on the terminal side and the base station side. After the terminal side acquires CSI via channel estimation, the CSI is compressed and encoded by a neural network of the encoder, and a compressed bitstream is fed back to the base station side through a feedback link of an air interface. According to the bitstream that is fed back, the base station side recovers the CSI through the decoder, to acquire the complete CSI. In the structure shown in FIG. 7, several fully connected layers are used in the encoder to perform encoding, and a convolutional neural network structure is used in the decoder to perform decoding, however, in a case that the codec framework is unchanged. It should be noted that the network model structures within the encoder and decoder do not preclude a flexible design based on the other models described above.

As one of machine learning methods, meta-learning has attracted much attention from the industry in recent years. The meta-learning is intended to provide a model with a capability to adjust hyperparameters, so that the model can quickly learn new tasks based on the existing knowledge that is acquired. That is, according to a large amount of data of different scenarios and different categories, a meta-learning algorithm (including, but not limited to, MAML, Reptile, etc.) can be used to train a model with a randomly initialized weight as a starting point, to acquire the meta model that had learned a large amount of basic knowledge. Since the meta model has been trained for the large amount of scenario data (the data for training the meta model may be divided into different scenarios, which may be referred to as different “tasks”), the meta model has the capability of fast training adaptation to a related target scenario by using a small amount of data of the target scenario.

In practical applications, for training the CSI feedback model by using the meta model, a huge amount of channel state information with high diversity is required. In terms of actual acquisition costs and acquisition difficulties, it is challenging to acquire the huge amount of channel data with high diversity

On that basis, according to an embodiment of the present disclosure, a method for training a model is provided. Specifically, a first device generates a plurality of pieces of sample data based on a first codebook of a precoding matrix. Further, the first device trains an initial CSI feedback model based on the plurality of pieces of sample data that are generated, to acquire a CSI feedback meta model. The CSI feedback meta model is used to train a target CSI feedback model, and the CSI feedback model is used to encode channel state information acquired by a signal receiving end, and further recover the encoded channel state information at a signal transmitting end. It can be seen that, considering that the precoding codebook can reflect actual channel state information to some extent, the sample data for training the CSI feedback meta model in the present disclosure may be generated according to the first codebook of the precoding matrix. Thus, there is no need to acquire the huge amount of CSI which is acquired via the channel estimation, thereby greatly reducing the difficulty and labor overhead of the sample data acquisition.

To facilitate the understanding of the technical schemes of the embodiments of the present disclosure, the technical schemes of the present disclosure will be described in detail below through specific embodiments. The foregoing related technologies may be arbitrarily combined with the technical schemes of the embodiments of the present disclosure as optional solutions, all of which fall within the scope of protection of the embodiments of the present disclosure. The embodiments of the present disclosure include at least some of the following contents.

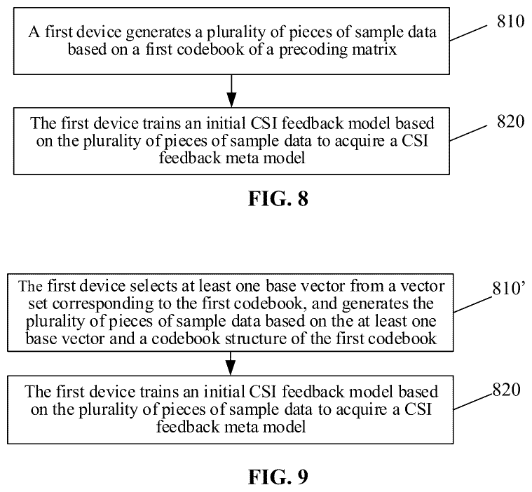

FIG. 8 is a first schematic flowchart of a method for training a model according to an embodiment of the present disclosure. As shown in FIG. 8, the method includes the following contents.

At block 810, a first device generates a plurality of pieces of sample data based on a first codebook of a precoding matrix.

At block 820, the first device trains an initial CSI feedback model based on the plurality of pieces of sample data to acquire a CSI feedback meta model.

The CSI feedback meta model is used to train a target CSI feedback model, and the target CSI feedback model is used to encode channel state information acquired by a signal receiving end, and recover the encoded channel state information at a signal transmitting end.

It should be understood that a “meta model” refers to a model having a large amount of basic knowledge (i.e., with a non-randomly initialized weight). That is, the meta model may be trained by using less data of a target scenario or a short period of time, i.e., the model adapted to the target scenario may be acquired, and the model can be retrained quickly and adapted to the target scenario by taking the meta model as the starting point of training. In other words, the CSI feedback meta model may be trained by using a small amount of real CSI acquired via the channel estimation, and the target CSI feedback model adapted to a real channel environment can be acquired.

In an embodiment, the first device may be any one of a server, a network device, or a terminal device.

That is, the training process of the CSI feedback meta model may be performed by a server, and the CSI feedback meta model may be deployed at two ends (for example, a network device and/or a terminal device) of signal transmission, to acquire the target CSI feedback model by performing the training according to an actual channel estimation result. Thus, the CSI feedback can be implemented at the two ends of signal transmission. In addition, the training process of the CSI feedback meta model may also be performed by a network device or a terminal device, which is not limited in the embodiments of the present disclosure.

It should be understood that the precoding codebook may approximately reflect the actual channel state information to certain extent. On that basis, the first device may generate the huge amount of sample data by using the precoding first codebook, and further perform the training based on the sample data, to acquire the CSI feedback meta model. In such manner, during the training process of the CSI feedback meta model according to the embodiments of the present disclosure, there is no need to acquire the huge amount of CSI which is acquired via the channel estimation, and the sample data is generated by using the precoding first codebook. Thus, the difficulty and labor overhead of sample data acquisition can be greatly reduced.

In an embodiment, the first codebook of the precoding matrix may include at least one of the following:
a type 1 (TypeI) codebook, a type 2 (TypeII) codebook, or an enhanced type 2 (eTypeII) codebook.

In an embodiment, referring to FIG. 9, the operation 810 of the first device generating the plurality of pieces of sample data based on the first codebook of the precoding matrix may be implemented in the following manner.

At block 810′, the first device selects at least one base vector from a vector set corresponding to the first codebook, and generates the plurality of pieces of sample data based on the at least one base vector and a codebook structure of the first codebook.

Here, the vector set corresponding to the first codebook may be all vectors included in a vector space that is constructed by the first device for the first codebook. The vector space may be a DFT vector space. The vector set corresponding to the first codebook may include a plurality of base vectors.

In the embodiments of the present disclosure, the first device may randomly select one or more base vectors from the vector set corresponding to the first codebook at a time. Based on a construction rule of the codebook structure of the first codebook, the one or more selected base vectors are combined to acquire one piece of sample data. The first device may perform such operation more than once, to acquire the plurality of pieces of sample data.

Exemplarily, in a case that the first codebook is the type 2 (TypeII) codebook, the first device may generate sample data according to the codebook structure W=W₁W₂ of the TypeII codebook. Here, W₁ in the TypeII codebook and W₁ in the eTypeII codebook structure are the same, and are both a diagonal block matrix W₁=[B, 0; 0, B]. W₂ in the TypeII codebook structure is combination coefficient information corresponding to L beams on a subband, which includes an amplitude and a phase. Coefficients in each layer and polarization direction are independently selected. On that basis, the first device may select one or more base vectors from the vector set corresponding to the TypeII codebook, arrange the one or more selected base vectors in columns to form the matrix B, and further form an angular block matrix W₁ based on the matrix B. The first device may randomly generate combination coefficient information corresponding to each layer and polarization direction to acquire the matrix W₂. Moreover, according to the W₁ and W₂, the first device may generate the precoding matrix W=W₁W₂, and further use the precoding matrix as a piece of sample data. The first device may repeat the aforementioned operations to acquire a plurality of pieces of sample data.

In an embodiment, referring to FIG. 9, before the operation 810′, the first device may further perform the following operations.

At block 800, the first device generates the vector set corresponding to the first codebook based on at least one of the number of antenna ports of the signal transmitting end, an oversampling factor, or the number of subbands.

That is, the vector set corresponding to the first codebook in the operation 810′ may be constructed by the first device based on at least one of the number of antenna ports of the signal transmitting end, the oversampling factor, or the number of subbands. After the vector construction corresponding to the first codebook is completed, the first device may generate the sample data based on the vector set that is constructed.

By taking an example in which the first codebook is the eTypeII codebook, the construction method for the vector set will be described in detail below.

In the case that the first codebook is the eTypeII codebook, the vector set corresponding to the first codebook may include a first vector set (for example, a vector set corresponding to W₁ in the eTypeII codebook) and a second vector set (for example, a vector set corresponding to W_{f} in the eTypeII codebook).

Accordingly, the operation 800 of the first device generating the vector set corresponding to the first codebook based on the at least one of the number of antenna ports of the signal transmitting end, the oversampling factor, or the number of subbands may be implemented in the following manner.

At block 8001, the first device generates the first vector set based on the number of antenna ports of the signal transmitting end and the oversampling factor.

At block 8002, the first device generates the second vector set based on the number of subbands.

In the embodiments of the present disclosure, the first device may perform a discrete Fourier transform operation according to dimensions of an antenna array of the signal transmitting end and an oversampling factor in each dimension, to generate the first vector set. Here, vectors in the first vector set are all DFT vectors.

Exemplarily, the antenna of the signal transmitting end is a two-dimensional planar array antenna, and the oversampling factor includes a first sampling factor O₁ and a second sampling factor O₂. The operation 8001 of the first device generating the first vector set based on the number of antenna ports of the signal transmitting end and the oversampling factor may be implemented in the following manner.

At an operation 8001a, the first device generates N₁O₁ first DFT vectors based on the first number N₁ of antenna ports of the signal transmitting end in a first dimension and the first sampling factor O₁.

At an operation 8001b, the first device generates N₂O₂ second DFT vectors based on the second number N₂ of antenna ports of the signal transmitting end in a second dimension and the second sampling factor O₂.

At an operation 8001c, the first device sequentially performs a Kronecker product operation on each of the N₁O₁ first DFT vectors and each of the N₂O₂ second DFT vectors, to acquire the first vector set.

In an embodiment, an m-th first DFT vector among the N₁O₁ first DFT vectors is determined via the following equation (2-1):

$$( 2 - 1 )$$

$${v}_{m} = {[ 1 , … , exp ( j 2 π ( x - 1 ) m ) / {N}_{1} {O}_{1} , … , exp ( j 2 π ( {N}_{1} - 1 ) m ) / {N}_{1} {O}_{1} ]}^{T}$$

where m is an integer greater than or equal to 0 or less than or equal to N₁O₁−1, and the value of x ranges from 2 to N₁−1.

In an embodiment, an n-th second DFT vector among the N₂O₂ second DFT vectors is determined via the following equation (2-2):

$$( 2 - 2 )$$

$${u}_{n} = {[ 1 , … , exp ( j 2 π ( y - 1 ) n ) / {N}_{2} {O}_{2} , … , exp ( j 2 π ( {N}_{2} - 1 ) n ) / {N}_{2} {O}_{2} ]}^{T}$$

where n is an integer greater than or equal to 0 or less than or equal to N₂O₂−1,and y is an integer greater than or equal to 1 or less than or equal to N₂.

In an embodiment, the first device may calculate the first vector set according to the following equation (2-3):

$${a}_{m , n} = {v}_{m} ⊗ {u}_{n} \qquad ( 2 - 3 )$$

It should be understood that the first vector set may include N₁O₁N₂O₂ DFT vectors.

In the embodiments of the present disclosure, the first device may perform the discrete Fourier transform operation according to the number of subbands, to generate the second vector set. Here, the second vector set includes Nsb DFT vectors, and Nsb is the number of subbands.

Exemplarily, the first device may generate an i-th DFT vector in the second vector set according to the following equation (2-4), the value of i ranging from 1 to Nsb:

$$( 2 - 4 )$$

$${q}_{j} = {[ 1 , … , exp ( j 2 π ( 𝓏 - 1 ) i ) / Nsb , … , exp ( j 2 π ( Nsb - 1 ) i ) / Nsb ]}^{T}$$

where a value of z ranges from 1 to Nsb.

It should be understood that the first vector set and the second vector set may constitute the vector set corresponding to the eTypeII codebook. After generating the first vector set and the second vector set of the eTypeII codebook, the first device may randomly select a base vector from the first vector set and the second vector set, and further construct, according to the codebook structure of the eTypeII codebook, the sample data for training the CSI feedback meta model.

It should be noted that, in order to acquire the meta model, it is required to train data of a large number of scenarios. In particular, in order to acquire the CSI feedback meta model, it is required to train the CSI data of a large number of different channel scenarios. It should be understood that the sample data used for training may be divided into different scenarios, which may be referred to as different tasks.

Based on the above reason, in the embodiments of the present disclosure, it may be considered that the first device may generate the sample data by using a scenario factor, when generating the plurality of pieces of sample data by using the first codebook.

In an embodiment, the plurality of pieces of sample data are formed by D sample data groups. Here, each of the sample data groups corresponds to one task, each of the sample data groups includes K pieces of sample data, where D and K are integers greater than 1. That is, the plurality of pieces of sample data to be generated may include D tasks, and each task includes K pieces of sample data. The first device may sequentially generate sample data in the D tasks.

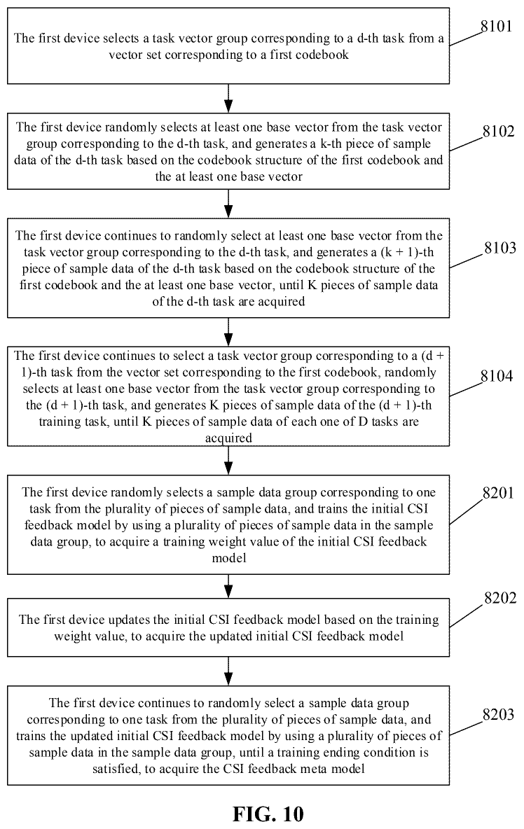

In an embodiment, referring to FIG. 10, the operation 810 of the first device generating the plurality of pieces of sample data based on the first codebook of the precoding matrix may be implemented by the following operations.

At block 8101, the first device selects a task vector group corresponding to a d-th task from the vector set corresponding to the first codebook, where d is an integer greater than or equal to 1 or less than or equal to D.

At block 8102, the first device randomly selects at least one base vector from the task vector group corresponding to the d-th task, and generates a k-th piece of sample data of the d-th task based on the codebook structure of the first codebook and the at least one base vector. Here, k is an integer greater than or equal to 1 or less than or equal to K.

At block 8103, the first device continues to randomly select at least one base vector from the task vector group corresponding to the d-th task, and generates a (k+1)-th piece of sample data of the d-th task based on the codebook structure of the first codebook and the at least one base vector, until K pieces of sample data of the d-th task are acquired.

At block 8104, the first device continues to select a task vector group corresponding to a (d+1)-th task from the vector set corresponding to the first codebook, randomly selects at least one base vector from the task vector group corresponding to the (d+1)-th task, and generates K pieces of sample data of the (d+1)-th training task, until K pieces of sample data of each one of D tasks are acquired.

In the embodiments of the present disclosure, when generating sample data for one task, the first device randomly selects a task vector group from a vector set corresponding to the first codebook at first. As such, when generating the sample data for the task, the first device may randomly select at least one base vector from the task vector group, and further process the at least one selected base vector according to the codebook structure of the first codebook, to acquire a piece of sample data of the task. Additionally, the first device may continue to randomly select at least one base vector from the task vector group, and further process the at least one selected base vector according to the codebook structure of the first codebook, to acquire another piece of sample data of the task, until K pieces of sample data are acquired. In such manner, generation of the sample data of the one task is completed.

Further, after completing the generation of sample data of the one task, the first device may continue to generate sample data for a next task. In this case, the first device may randomly select a task vector group from the vector set corresponding to the first codebook, and generate K pieces of sample data for the current task through the task vector group, until generation of sample data of the D-th task is completed.

In an embodiment, the number of base vectors included in the task vector group corresponding to each task is greater than the number of base vectors required in the sample data of the task.

It can be seen that, in the present disclosure, the first device may simulate different scenarios to generate sample data corresponding to different tasks, so that the sample data for training the CSI feedback meta model can be better adapted to actual training requirements, thereby improving the diversity of the sample data and the reliability of the training.

By taking an example in which the first codebook is the eTypeII codebook, the method for generating the sample data will be described in detail below.

According to the aforementioned embodiments, the vector set corresponding to the eTypeII codebook includes a first vector set and a second vector set. Here, the first vector set includes N₁O₁N₂O₂ DFT vectors, and the second vector set includes Nsb DFT vectors.

In an embodiment, after generating the first vector set and the second vector set corresponding to the eTypeII codebook based on the aforementioned embodiments, the first device may construct the sample data according to the following operations A to J.

At the operation A, the first device randomly selects a subset from a plurality of subsets of the first vector set, to acquire a target subset. Here, any two DFT vectors in each of the plurality of subsets are orthogonal to each other.

In an embodiment, the first device may divide the first vector set into O₁*O₂ subsets, and each subset includes N₁*N₂ DFT vectors that are orthogonal to each other. Specifically, the first device may divide the first vector set into a plurality of subsets according to the following rule.

The first vector set is acquired by performing a Kronecker product operation on the first DFT vector, each of the N₁O₁ first DFT vectors, and each of the N₂O₂ second DFT vectors.

On that basis, the first device may divide the N₁O₁ first DFT vectors in a first dimension (e.g., the horizontal direction) into O₁ first groups, and two adjacent DFT vectors in each first group are separated by O₁ first DFT vectors.

In an embodiment, a DFT vector included in the q-th first group in the O₁ first groups may be calculated according to the following equation (2-5), here, q is an integer greater than or equal to 1 or less than or equal to O₁:

$$( 2 - 5 )$$

$${v}_{m} = {[ 1 , … , exp ( j 2 π ( x - 1 ) m ) / {N}_{1} {O}_{1} , … , exp ( j 2 π ( {N}_{1} - 1 ) m ) / {N}_{1} {O}_{1} ]}^{T}$$

where m=q−1, O₁+q−1, 2O₁+q−1, . . . , (N₁−1)O₁+q−1.

In addition, the first device may further divide the N₂O₂ second DFT vectors in a second dimension (e.g., the vertical direction) into O₂ second groups, and two adjacent DFT vectors in each second group are separated by O₂ second DFT vectors.

In an embodiment, a DFT vector included in the p-th second group in the O₂ second groups may be calculated according to the following equation (2-6), here, p is an integer greater than or equal to 1 or less than or equal to O₂:

$$( 2 - 6 )$$

$${u}_{n} = {[ 1 , … , exp ( j 2 π ( y - 1 ) n ) / {N}_{2} {O}_{2} , exp ( j 2 π ( {N}_{2} - 1 ) n ) / {N}_{2} {O}_{2} ]}^{T}$$

$$where n = p - 1 , {O}_{2} + p - 1 , 2 {O}_{2} + p - 1 , … , ( {N}_{2} - 1 ) {O}_{2} + p - 1.$$

In the embodiments of the present disclosure, the (q*p)-th subset among the O₁*O₂ subsets includes a result of sequentially calculating a Kronecker product of each DFT vector in the q-th first group with each DFT vector in the p-th second group.

In an embodiment, a DFT vector included in the (q*p)-th subset among the O₁*O₂ subsets may be acquired according to the following equation (2-7):

$${a}_{m , n}^{′} = {v}_{m} ⊗ {u}_{n} \qquad ( 2 - 7 )$$

It should be noted that, in the equation (2-7) above, m=q−1, O₁+q−1, 2O₁+q−1, . . . , (N₁−1)O₁+q−1, and n=p−1, O₂+p−1, 2O₂+p−1, . . . , (N₂−1)O₂+p−1.

Based on the aforementioned method, the first device may divide the first vector set into O₁*O₂ subsets, and each subset includes N₁*N₂ DFT vectors that are orthogonal to each other.

Exemplarily, when N₁=N₂=O₁=O₂=4, the first device may construct the first vector set as shown in FIG. 11. Each circle in FIG. 11 represents a DFT vector in the first vector set. The filled circles may represent all DFT vectors without oversampling, and the hollow circles may represent DFT vectors acquired with oversampling. It should be understood that the filled circles and the hollow circles may form all DFT vectors via the oversampling.

In the embodiments of the present disclosure, the first device may randomly select, from the O₁*O₂ subsets, a subset including N₁N₂ subsets that are orthogonal to each other as the target subset. Exemplarily, referring to FIG. 11, the first device may select, from the first vector set, an orthogonal vector group framed by a box as the target subset.

At the operation B, the first device randomly selects a plurality of base vectors from the target subset, to acquire a first task vector group corresponding to the d-th task.

It should be understood that the sample data to be generated includes D tasks, and each task includes K pieces of sample data.

Exemplarily, for the d-th task, the first device may randomly select Lₜₐₛₖ base vectors from the target subset selected at the operation A, to acquire the first task vector group corresponding to the d-th task.

At the operation C, the first device randomly selects a plurality of base vectors from the second vector set, to acquire a second task vector group corresponding to the d-th task.

Similarly, for the d-th task, the first device may randomly select Mₜₐₛₖ base vectors from the constructed second vector set, to acquire the second task vector group corresponding to the d-th task.

At the operation D, the first device randomly selects at least one first base vector from the first task vector group, and generates a matrix B based on the at least one first base vector.

In the embodiments of the present disclosure, the first device may randomly select L first base vectors from the first task vector group, and further form the matrix B by using the L first base vectors as columns. Here, L<Lₜₐₛₖ, and B∈C^{N1N2×L}.

Exemplarily, referring to FIG. 11, the first device may generate the matrix B by using four DFT vectors, which are selected via a dotted box from 16 DFT vectors framed by a box that are mutually orthogonal to each other.

At the operation E, based on the matrix B, a first matrix W₁ in the first codebook structure is generated.

It should be understood that the first matrix W₁=[B, 0; 0, B]∈C^{2N1N2×2L}.

At the operation F, the first device selects at least one second base vector from the second task vector group, and generates a second matrix W_{f} in the first codebook structure based on the at least one second base vector.

Specifically, the first device may randomly select M second base vectors from the second task vector group, and arrange the M base vectors in rows to form the second matrix W_{f}. Here, M<Mₜₐₛₖ, and the second matrix W_{f}∈C^{M×Nsb}.

At the operation G, a random number matrix W₂ is constructed.

In the embodiments of the present disclosure, both a real part and an imaginary part of each element in the random number matrix W₂ follow a uniform distribution of U˜[0, 1].

At the operation H, the k-th piece of sample data of the d-th task is generated based on the first matrix W₁, the second matrix W_{f}, and the random number matrix W₂.

Here, the first device performs a matrix product operation on the above three matrices, based on the codebook structure W=W₁W₂W_{f} of the eTypeII codebook, to generate a piece of sample data.

In an embodiment, the first device may further perform normalization processing on a result of the aforementioned operation, to acquire final sample data. Specifically, Nsb column vectors are included in a matrix W that is acquired by the first device by performing the matrix product operation on the above three matrices. The Nsb column vectors may be represented by [w₁, . . . , W_{Nsb}]. The first device may perform normalization processing on each column in the matrix W, to acquire the final sample data W′=[w₁/norm (w₁), . . . , w_{Nsb}/norm (w_{Nsb})]. Here, norm (⋅) represents a two-norm.

At the operation I, the first device returns to the operation D, to continue to generate the (k+1)-th piece of sample data in the d-th task, until generation of all K pieces of sample data in the d-th task is completed.

At the operation J, the first device returns to the operation A, to continue to generate sample data of the (d+1)-th task, until generation of sample data of all the D tasks is completed.

In an embodiment, referring to FIG. 10, the operation 820 of the first device training the initial CSI feedback model based on the plurality of pieces of sample data to acquire the CSI feedback meta model may be implemented in the following manner.

At block 8201, the first device randomly selects a sample data group corresponding to one task from the plurality of pieces of sample data, and trains the initial CSI feedback model by using a plurality of pieces of sample data in the sample data group, to acquire a training weight value of the initial CSI feedback model.

At block 8202, the first device updates the initial CSI feedback model based on the training weight value, to acquire the updated initial CSI feedback model.

At block 8203, the first device continues to randomly select a sample data group corresponding to one task from the plurality of pieces of sample data, and trains the updated initial CSI feedback model by using a plurality of pieces of sample data in the sample data group, until a training ending condition is satisfied, to acquire the CSI feedback meta model.

It should be understood that, after generating the plurality of pieces of sample data by using the first codebook of the precoding matrix, the first device may train the CSI feedback meta model by using the plurality of pieces of sample data that are generated.

In the embodiments of the present disclosure, the first device may firstly construct the initial CSI feedback model. It should be noted that a weight value (which may also be referred to as a model parameter) of the initial CSI feedback model is randomly initialized.

After constructing the initial CSI feedback model, the first device may randomly select a sample data group corresponding to one task from the plurality of pieces of sample data. Next, the first iterative training is performed on the initial CSI feedback model by using the sample data group.

It should be noted that the CSI feedback model is used to encode channel state information and further recover the encoded channel state information at an opposite end, thus, in the embodiments of the present disclosure, tag information of each piece of sample data during the training process is the sample data itself.

Specifically, during an iterative training process of the CSI meta model, the first device may input a first piece of sample data in a selected sample data group into the initial CSI feedback model, and calculate a difference value between a first output result output by the initial CSI feedback model and the tag information of the first piece of sample data (for example, the difference value is calculated via a preset loss function). Additionally, the first device may adjust, based on the difference value, the weight value of the initial CSI feedback model, to acquire the initial CSI feedback model with the adjusted weight. Then, the first device may input a second piece of sample data in the selected sample data group into the initial CSI feedback model with the adjusted weight, and calculate a difference value between a second output result output by the initial CSI feedback model with the adjusted weight and the tag information of the second piece of sample data. Additionally, the first device may further adjust, based on the difference value, the weight value of the initial CSI feedback model with the adjusted weight.

It should be understood that, according to the above training process, the first device may traverse the sample data in the selected sample data group. Here, one time of traversing the sample data in the sample data group may be referred to as one round of training. After multiple rounds of training, the training weight value of the initial CSI feedback model may be acquired.

In an embodiment, after training the initial CSI feedback model for multiple rounds by using the selected sample data group, the first device may acquire the weight value of the initial CSI feedback model. The first device may determine the training weight value by using an updating step size and the weight value of the initial CSI feedback model with the training for multiple rounds.

Exemplarily, the first device may calculate the training weight value according to the following equation (2-8):

$${θ}^{′} = {θ}_{0} + λ ( {θ}_{s} - {θ}_{0} ) \qquad ( 2 - 8 )$$

where θ₀ is the initialized weight value of the initial CSI feedback model, θₛ is a weight value of the initial CSI feedback model with the training for multiple rounds, λ is the updating step size, and θ′ is the training weight value.

It should be noted that the updating step size may be a pre-configured value. For example, the updating step size may be an empirical value.

In the embodiments of the present disclosure, after acquiring the training weight value, the first device may update the weight value of the initial CSI feedback model as the training weight value.

Further, the first device may perform a next iterative training on the updated initial CSI feedback model. That is, the first device continues to randomly select a sample data group corresponding to one task from the plurality of pieces of sample data, and further trains the updated initial CSI model for multiple rounds by using the sample data in the selected sample data group, to acquire the weight value after the training for multiple rounds. In addition, the training weight value of the current iterative training is determined by using the updating step size and the weight value. The first device updates the weight value of the initial CSI feedback model according to the calculated training weight value of the current iterative training. In such manner, the first device may continue to perform the next iterative training, until the training ending condition is satisfied. The first device may take the initial CSI feedback model that satisfies the training ending condition as the CSI feedback meta model.

In an embodiment, the training ending condition may include one of the following:
the number of training times satisfying the maximum number of training times, or
similarity between data output by the CSI feedback meta model and data input to the CSI feedback meta model being greater than a preset threshold.

Here, the maximum number of training times may be a preset value. The maximum number of training times may be the total number of training times of the initial CSI feedback model, or may refer to the maximum number of iterations of training of the initial CSI feedback model, which is not limited in the embodiments of the present disclosure.

In addition, the similarity between data output by the CSI feedback meta model and the data input to the CSI feedback meta model being greater than the preset threshold may also be understood as that the performance of the CSI feedback meta model with the iterative training for several times does not improve any more.

It should be noted that the process of each iterative training is the same as that of the first iterative training, which is not described in detail herein for the sake of brevity.

Exemplarily, the process of training the CSI feedback meta model may include operations a to f. Specifically, at the operation a, the first device may initialize the weight value of the initial CSI feedback model, to acquire the weight value θ₀. At the operation b, the first device may select the sample data group corresponding to the d-th task from the D tasks, such that the first device may perform the training based on the sample data group corresponding to the d-th task. Here, d is an integer greater than or equal to 1 and less than or equal to D.

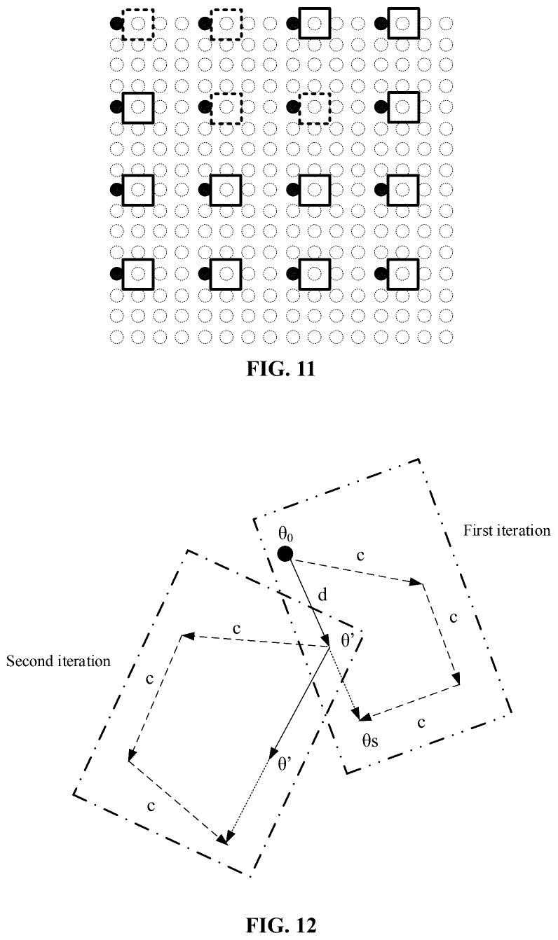

Referring to FIG. 12, at the operation c, the first device may perform the training for three rounds by using the sample data group corresponding to the d-th task. Each dashed line shown in FIG. 12 represents one round of training. The weight value of the initial CSI feedback model with the training for three rounds is θₛ. At the operation d, the first device may calculate the training weight value θ′ based on the equation (2-1). At the operation e, the first device may update the weight of the initial CSI feedback model as θ′, that is, setting θ₀=θ′. At the operation f, the first device may return to the operation b to perform the second iterative training by using θ₀=θ′ as a starting point, until the ending condition is satisfied, to acquire the CSI feedback meta model.

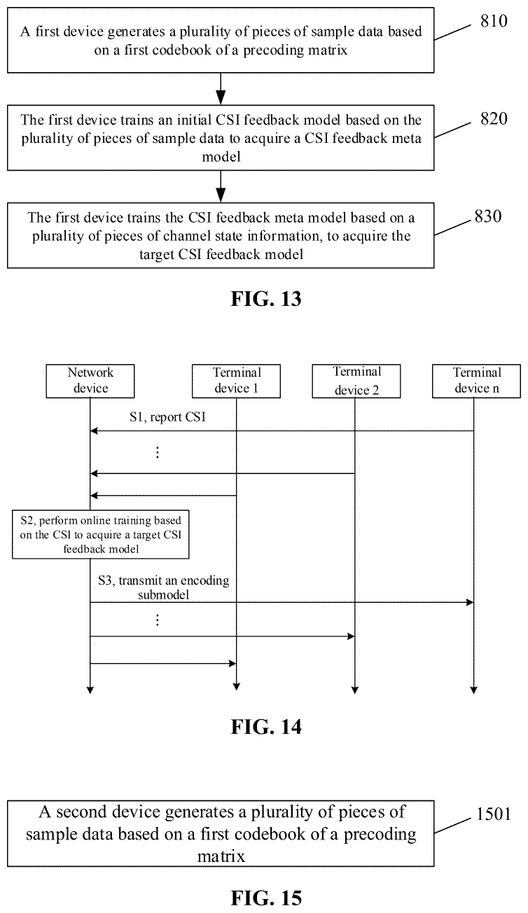

In an embodiment, referring to FIG. 13, the method for training the model according to the embodiments of the present disclosure may further include the following operations.

At block 830, the first device trains the CSI feedback meta model based on a plurality of pieces of channel state information, to acquire the target CSI feedback model. Herein, the plurality of pieces of channel state information are acquired by performing channel estimation on a plurality of CSI-RSs, and the number of the plurality of pieces of channel state information is less than a first number.

It should be understood that the method for training the model may include two phases: an off-line training phase and an online training phase. In the off-line training phase, a plurality of pieces of sample data may be generated according to the first codebook, and the training may be performed by using the initial CSI feedback model with the randomly initialized weight as the starting point, to acquire the CSI feedback meta model. That is, the off-line training phase may include the training process of the operations 810 to 820 described above. It should be noted that the sample data in the off-line training phase may be a huge amount of data, and the off-line training phase requires a long training time.

In addition, in the online training phase, real channel state information may be used, and the training is performed by using the CSI feedback meta model as the starting point, to acquire the target CSI feedback model adapted to the real radio frequency environment. That is, the online training phase may include the training process of the operation 830.

It should be understood that the training data in the online training phase is the CSI that is acquired by performing channel estimation on the real CSI-RS. The CSI feedback meta model is trained by using a huge amount of sample data, and has the non-randomly initialized weight. Thus, for the training data (i.e., the channel state information) in the online training phase, a small amount of real channel state information is used for the training, to acquire the target CSI feedback model adapted to the real radio frequency environment.

In an embodiment, the number of pieces of channel state information used to train the target CSI feedback model in the operation 830 may be less than the first number. Exemplarily, the first data may be 100, 50, etc.

In the embodiments of the present disclosure, the training data in the online training phase is less, such that the training can be completed within a short training time, to acquire the target CSI feedback model adapted to the real radio frequency environment.

It should be noted that the real channel state information in the online training phase may be acquired by the signal receiving end performing the channel estimation according to the CSI-RS in a real data transmission process.

In an embodiment, if the first device is a server, the server may acquire the plurality of pieces of CSI acquired by the signal receiving end performing the channel estimation. Further, the first device may perform the online training on the CSI feedback meta model by using the plurality of pieces of CSI that are acquired, to acquire the target CSI feedback model. In addition, the first device may deploy an encoding submodel of the target CSI feedback model at the signal receiving end, to perform encoding processing on channel state information acquired by the signal receiving end via the estimation. The first device may further deploy a decoding submodel of the target CSI feedback model at the signal transmitting end, to decode the channel state information that has undergone the encoding processing and is fed back by the signal receiving end.

In an embodiment, if the first device is a terminal device, the terminal device may perform the online training by using a plurality of pieces of downlink CSI that are acquired via the channel estimation based on the CSI-RS for multiple times. As such, the target CSI feedback model adapted to the current radio frequency environment can be acquired. Further, the terminal device may transmit the decoding submodel and/or the encoding submodel in the target CSI feedback model to the opposite end that performs data transmission with the terminal device.

In an embodiment, if the first device is a network device, the network device may indicate multiple terminal devices served by the network device, to report the CSI that is acquired via the channel estimation based on the CSI-RS. In such manner, the network device may perform the online training by using the CSI reported by the multiple terminal devices. As such, the target CSI feedback model adapted to the current radio frequency environment can be acquired. Further, the network device may transmit the decoding submodel and/or the encoding submodel in the target CSI feedback model to the multiple terminal devices served by the network device.

It should be noted that, if the device for the off-line training is a server, the online training may be performed by two ends (the signal receiving end or the signal transmitting end) of signal transmission, when the online training needs to be performed. For example, the server performs the off-line training to acquire the CSI feedback meta model. The two ends of signal transmission may download the CSI feedback meta model from the server before performing the data transmission, and further acquire, during the data transmission with the opposite end, the real CSI that is acquired via the channel estimation based on the CSI-RS. As such, the online training is performed to acquire the target CSI feedback model adapted to the current radio frequency environment. Considering that the network device has a higher computing capacity and a higher storage capacity, the online training may be performed by the network device.

Description is provided by taking an example in which the network device performs the online training. Referring to FIG. 14, the online training performed by the network device may include operations S1 to S3. Specifically, at the operation S1, multiple terminal devices served by the network device may respectively perform the channel estimation based on the CSI-RS to acquire a plurality of pieces of downlink CSI, and further report the acquired CSI to the network device. Here, the network device may instruct the preset number of (e.g., 10) terminal devices to report the CSI, and each terminal device may report the CSI of a preset number of (e.g., 10) slots. Such CSI information may forms a small amount of sample data. At the operation S2, the network device may use the small amount of sample data acquired in the operation S1 to train the CSI feedback meta model, further to acquire the target CSI feedback model. At the operation S3, the network device transmits the encoding submodel of the target CSI feedback model to all terminal devices served by the network device, thereby completing the deployment of the target CSI feedback model.

On that basis, when performing the data transmission with the network device, the terminal device may perform the encoding processing on the channel state information that is acquired by using the encoding submodel in the target CSI feedback model, and further report the encoded channel state information to the network device. In such manner, the network device may decode, by using the decoding submodel in the target CSI feedback model, the information reported by the terminal device, and further recover the channel state information that is acquired by the terminal device.

To sum up, in the method for training the model according to the embodiments of the present disclosure, a data set of the CSI feedback meta model may be generated based on a codebook, and the data set is used to perform the off-line training for acquiring the CSI feedback meta model. As such, the meta model can be constructed without the data acquired in real time, and thus, the acquisition costs of sample data can be reduced. In addition, based on the CSI feedback meta model, the online training may be further completed by using the real channel state information. As such, the online training of the model can be completed quickly in the case that the data amount of the channel state information is less, and the model can be adapted to the real radio frequency environment, thereby greatly reducing the acquisition costs of real data, and the computing capacity requirements as well as the training time requirements for the model training.

Based on the aforementioned embodiments, the method for generating the sample data is further provided according to an embodiment of the present disclosure. Referring to FIG. 15, the method may include the following operation.

At block 1501, a second device generates a plurality of pieces of sample data based on a first codebook of a precoding matrix. Here, the plurality of pieces of sample data are used to train an initial CSI feedback model, to acquire a CSI feedback meta model. Herein, the CSI feedback meta model is used to train a target CSI feedback model, and the CSI feedback model is used to encode channel state information acquired by a signal receiving end, and recover the encoded channel state information at a signal transmitting end.

In the embodiments of the present disclosure, the second device may generate a plurality of pieces of sample data based on only the first codebook of the precoding matrix, to provide the plurality of pieces of sample data that are generated to other devices for training the CSI feedback meta model.

In an embodiment, the second device may be a server, a terminal device, a network device, or the like, which is not limited in the embodiments of the present disclosure.

Exemplarily, the second device may be the network device. The network device may generate the plurality of pieces of sample data by using the first codebook, and further transmit the sample data that is generated to a server with a larger computing capacity. As such, the training of the CSI feedback meta model is completed by using the computing capacity of the server, thereby improving the speed and efficiency of the model training.

In an embodiment, the first codebook includes at least one of the following:
a type 1 codebook, a type 2 codebook, or an enhanced type 2 codebook.

In an embodiment, the operation of the second device generating the plurality of pieces of sample data based on the first codebook of the precoding matrix may be implemented in the following manner.

The second device selects at least one base vector from a vector set corresponding to the first codebook, and generates the plurality of pieces of sample data based on the at least one base vector and a codebook structure of the first codebook.

In an embodiment, before selecting the at least one base vector from the vector set corresponding to the first codebook, the second device may further perform the following operation.

The second device generates the vector set corresponding to the first codebook based on at least one of the number of antenna ports of the signal transmitting end, an oversampling factor, or the number of subbands.

In an embodiment, the plurality of pieces of sample data are formed by D sample data groups. Here, each of the sample data groups corresponds to one task, and each of the sample data groups includes K pieces of sample data, where D and K are integers greater than 1.

In an embodiment, the operation of the second device generating the plurality of pieces of sample data based on the first codebook of a precoding matrix may include the following operations.

The first device selects a task vector group corresponding to a d-th task from the vector set corresponding to the first codebook, where d is an integer greater than or equal to 1 or less than or equal to D.

The first device randomly selects at least one base vector from the task vector group corresponding to the d-th task, and generates a k-th piece of sample data of the d-th task based on the codebook structure of the first codebook and the at least one base vector. Here, k is an integer greater than or equal to 1 or less than or equal to K.

The first device continues to randomly select at least one base vector from the task vector group corresponding to the d-th task, and generates a (k+1)-th piece of sample data of the d-th task based on the codebook structure of the first codebook and the at least one base vector, until K pieces of sample data of the d-th task are acquired.

The first device continues to select a task vector group corresponding to a (d+1)-th task from the vector set corresponding to the first codebook, randomly selects at least one base vector from the task vector group corresponding to the (d+1)-th task, and generates K pieces of sample data of the (d+1)-th training task, until K pieces of sample data of each one of D tasks are acquired.

It should be noted that, the method implemented by the second device to generate the plurality of pieces of sample data based on the first codebook of the precoding matrix is the same as the method implemented by the first device to generate the plurality of pieces of sample data based on the first codebook in the aforementioned embodiments, which is not described in detail herein again for the sake of brevity.

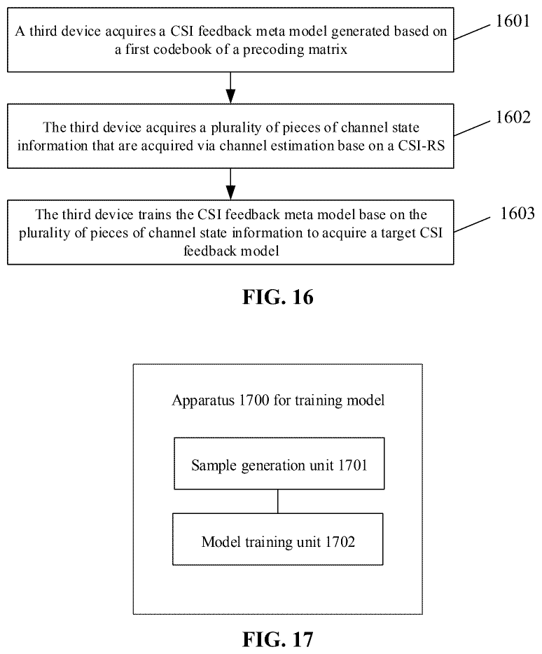

Based on the aforementioned embodiments, the method for training the model is further provided according to another embodiment of the present disclosure. Referring to FIG. 16, the method may include the following operations.

At block 1601, a third device acquires a CSI feedback meta model. Here, the CSI feedback meta model is generated based on a first codebook of a precoding matrix.

At block 1602, the third device acquires a plurality of pieces of channel state information. Here, the plurality of pieces of channel state information are acquired via channel estimation based on a CSI-RS.

At block 1603, the third device trains the CSI feedback meta model based on the plurality of pieces of channel state information to acquire a target CSI feedback model.

In the embodiments of the present disclosure, the third device may perform only an online training process. Specifically, the third device may download the trained CSI feedback meta model or acquire the trained CSI feedback meta model from another device, and further perform the online training on the CSI feedback meta model by using the plurality of pieces of channel state information that are actually acquired. Thus, the target CSI feedback model adapted to the real radio frequency environment can be acquired.

In an embodiment, the third device may be a server, a terminal device, a network device, or the like, which is not limited in the embodiments of the present disclosure.

Exemplarily, the third device may be the network device. The network device may download the CSI feedback meta model from a server, and instruct multiple terminal devices served by the network device to report the channel state information that is acquired via the channel estimation based on the CSI-RS in multiple slots. In such manner, the network device may perform the online training on the acquired CSI feedback meta model, based on the plurality of pieces of channel state information that is reported by the terminal devices. Thus, the target CSI feedback model can be acquired.

In an embodiment, the number of pieces of channel state information used to train the target CSI feedback model in the operation 1603 may be less than a first number. Exemplarily, the first data may be 100, 50, or the like.

In an embodiment, after acquiring the target CSI feedback model, the third device may further deploy the target CSI feedback model. Exemplarily, if the third device is the network device, the network device may transmit an encoding submodel in the target CSI feedback model to all the terminal devices served by the network device. In such manner, when performing the data transmission with the network device, the terminal device may perform encoding processing on the channel state information that is acquired by using the encoding submodel in the target CSI feedback model, and further report the encoded channel state information to the network device. In such manner, the network device may decode, by using the decoding submodel in the target CSI feedback model, the information reported by the terminal device, and further recover the channel state information that is acquired by the terminal device.

Preferred implementations of the present disclosure have been described in detail above in combination with the accompanying drawings, but the present disclosure is not limited to the specific details in the aforementioned implementations. Within the scope of the technical conception of the present disclosure, a variety of simple variations can be made to the technical schemes of the present disclosure, and such simple variations all fall within the scope of protection of the present disclosure. For example, various specific technical features described in the aforementioned specific implementations may be combined in any suitable manners without contradictions. In order to avoid unnecessary repetition, various possible combinations are not further described in the present disclosure. For another example, any combination may be made between various implementations of the present disclosure, as long as it does not depart from the idea of the present disclosure, and is likewise to be regarded as the contents of the present disclosure. For another example, on the premise of no conflict, various embodiments described in the present disclosure and/or the technical features in the various embodiments can be combined with the related art at will. The technical schemes acquired after the combination shall also fall within the scope of protection of the present disclosure.

It should be understood that, in various method embodiments of the present disclosure, the size of the sequence numbers of aforementioned processes does not imply the sequence of execution. The sequence of execution of the processes shall be determined by functions and internal logic thereof, and shall not constitute any limitation on the implementation process of the embodiments of the present disclosure.

FIG. 17 is a schematic structural composition diagram of an apparatus 1700 for training a model according to an embodiment of the present disclosure. As shown in FIG. 17, the apparatus 1700 for training the model includes a sample generation unit 1701 and a model training unit 1702.

The sample generation unit 1701 is configured to generate a plurality of pieces of sample data based on a first codebook of a precoding matrix.

The model training unit 1702 is configured to: train an initial channel state information (CSI) feedback model based on the plurality of pieces of sample data to acquire a CSI feedback meta model. Here, the CSI feedback meta model is used to train a target CSI feedback model, and the target CSI feedback model is used to encode channel state information acquired by a signal receiving end, and recover the encoded channel state information at a signal transmitting end.

In an embodiment, the model training unit 1702 is further configured to train the CSI feedback meta model based on a plurality of pieces of channel state information, to acquire the target CSI feedback model. Here, the plurality of pieces of channel state information is acquired by performing channel estimation on a plurality of channel state information reference signals (CSI-RSs), and the number of the plurality of pieces of channel state information is less than a first number.

In an embodiment, the first codebook includes at least one of the following:
a type 1 codebook, a type 2 codebook, or an enhanced type 2 codebook.

In an embodiment, the sample generation unit 1701 is further configured to: select at least one base vector from a vector set corresponding to the first codebook, and generate the plurality of pieces of sample data based on the at least one base vector and a codebook structure of the first codebook.

In an embodiment, the apparatus 1700 for training the model further includes a generation unit. The generation unit is configured to generate the vector set corresponding to the first codebook based on at least one of the number of antenna ports of the signal transmitting end, an oversampling factor, or the number of subbands.

In an embodiment, the plurality of pieces of sample data are formed by D sample data groups, each of the sample data groups corresponds to one task, and each of the sample data groups includes K pieces of sample data, where D and K are integers greater than 1.

In an embodiment, the sample generation unit 1701 is configured to: select a task vector group corresponding to a d-th task from a vector set corresponding to the first codebook, where d is an integer greater than or equal to 1 or less than or equal to D; and randomly select at least one base vector from the task vector group corresponding to the d-th task, and generate a k-th piece of sample data of the d-th task based on the codebook structure of the first codebook and the at least one base vector, where k is an integer greater than or equal to 1 or less than or equal to K. The sample generation unit 1701 is configured to: continue to randomly select the at least one base vector from the task vector group corresponding to the d-th task, and generate a (k+1)-th piece of sample data of the d-th task based on the codebook structure of the first codebook and the at least one base vector, until K pieces of sample data of the d-th task are acquired; and continue to select a task vector group corresponding to a (d+1)-th task from the vector set corresponding to the first codebook, randomly select at least one base vector from the task vector group corresponding to the (d+1)-th task, and generate K pieces of sample data of the (d+1)-th training task, until K pieces of sample data of each of D tasks are acquired.

In an embodiment, the first codebook is an enhanced type 2 codebook. The generation unit is further configured to: generate a first vector set based on the number of antenna ports of the signal transmitting end and the oversampling factor; and generate a second vector set based on the number of subbands. Here, the first vector set and the second vector set are included in the vector set.

In an embodiment, an antenna of the signal transmitting end is a two-dimensional planar array antenna, and the sampling factor includes a first sampling factor O₁ and a second sampling factor O₂. Correspondingly, the generation unit is further configured to: generate N₁O₁ first discrete Fourier transform (DFT) vectors based on the first number N₁ of antenna ports of the signal transmitting end in a first dimension and the first sampling factor O1; generate N₂O₂ second DFT vectors based on the second number N₂ of antenna ports of the signal transmitting end in a second dimension and the second sampling factor O₂; and sequentially perform a Kronecker product operation on each of the N₁O₁ first DFT vectors and each of the N₂O₂ second DFT vectors to acquire the first vector set.

In an embodiment, an m-th first DFT vector among the N₁O₁ first DFT vectors is determined through the following operational relationship:

$${v}_{m} = {[ 1 , … , exp ( j 2 π ( x - 1 ) m ) / {N}_{1} {O}_{1} , … , exp ( j 2 π ( {N}_{1} - 1 ) m ) / {N}_{1} {O}_{1} ]}^{T}$$

where m is an integer greater than or equal to 0 or less than or equal to N₁O₁−1, and a value of x ranges from 2 to N₁−1.

An n-th second DFT vector among the N₂O₂ second DFT vectors is determined through the following operational relationship:

$${u}_{n} = {[ 1 , … , exp ( j 2 π ( y - 1 ) n ) / {N}_{2} {O}_{2} , … , exp ( j 2 π ( {N}_{2} - 1 ) n ) / {N}_{2} {O}_{2} ]}^{T}$$

where n is an integer greater than or equal to 0 or less than or equal to N₂O₂−1, and a value of y ranges from 2 to N₂−1.

In an embodiment, the number of subbands is Nsb, and the generation unit is further configured to generate an i-th DFT vector in the second vector set according to the following operational relationship, a value of i ranging from 1 to Nsb,

$${q}_{i} = {[ 1 , … , exp ( j 2 π ( 𝓏 - 1 ) i ) / Nsb , … , exp ( j 2 π ( Nsb - 1 ) i ) / Nsb ]}^{T}$$

where a value of z ranges from 1 to Nsb.

In an embodiment, the sample generation unit 1701 is further configured to: randomly select a subset from a plurality of subsets of the first vector set to acquire a target subset, where any two DFT vectors in each of the plurality of subsets are orthogonal to each other; randomly select a plurality of base vectors from the target subset to acquire a first task vector group corresponding to the d-th task; and randomly select a plurality of base vectors from the second vector set to acquire a second task vector group corresponding to the d-th task. Here, the first task vector group and the second task vector group are included in the task vector group corresponding to the d-th task.

In an embodiment, the N₁O₁ first DFT vectors are divided into O₁ first groups, and two adjacent DFT vectors in each first group are separated by O₁ first DFT vectors.

The N₂O₂ second DFT vectors are divided into O₂ second groups, and two adjacent DFT vectors in each second group are separated by O₂ second DFT vectors.

The first vector set is divided into O₁*O₂ subsets, and each subset includes N₁*N₂ DFT vectors. Here, a (q*p)-th subset among the plurality of subsets includes a result of sequentially calculating a Kronecker product of each DFT vector in a q-th first group with each DFT vector in a p-th second group, where a is an integer greater than or equal to 1 or less than or equal to O₁, and b is an integer greater than or equal to 1 or less than or equal to O₂.

In an embodiment, the sample generation unit 1701 is further configured to: randomly select at least one first base vector from the first task vector group, and generate a matrix B based on the at least one first base vector; generate a first matrix W₁ in the structure of the first codebook based on the matrix B; select at least one second base vector from the second task vector group, and generate a second matrix W_{f} in the structure of the first codebook based on the at least one second base vector; construct a random number matrix W₂; and generate the k-th piece of sample data of the d-th task based on the first matrix W, the second matrix W_{f}, and the random number matrix W₂.

In an embodiment, the model training unit 1702 is further configured to: randomly select a sample data group corresponding to one task from the plurality of pieces of sample data, and train the initial CSI feedback model by using a plurality of pieces of sample data in the sample data group, to acquire a training weight value of the initial CSI feedback model; update the initial CSI feedback model based on the training weight value, to acquire the updated initial CSI feedback model; and continue to randomly select a sample data group corresponding to one task from the plurality of pieces of sample data, and train the updated initial CSI feedback model by using a plurality of pieces of sample data in the sample data group, until a training ending condition is satisfied, to acquire the CSI feedback meta model.

In an embodiment, the training ending condition includes one of the following:
a number of training times satisfying a maximum number of training times, or
similarity between data output by the CSI feedback meta model and data input to the CSI feedback meta model being greater than a preset threshold.

In an embodiment, the first device is any one of a server, a network device, or a terminal device.

In an embodiment, the first device is a network device. The model training unit 1702 is further configured to: receive a plurality of pieces of channel state information from at least one terminal device, where the plurality of pieces of channel state information are acquired by the at least one terminal device by performing channel estimation based on a channel state information reference signal; and train the CSI feedback meta model based on the plurality of pieces of channel state information to acquire the target CSI feedback model.

In an embodiment, the first device is a network device. The apparatus 1700 for training the model includes a transmission unit, which is configured to transmit an encoding submodel of the CSI feedback model to the at least one terminal device. The encoding submodel is used to encode channel state information.

It should be understood by those skilled in the art that the relevant description of the aforementioned apparatus for training the model according to the embodiments of the present disclosure may be understood with reference to the relevant description of the method for training the model according to the embodiments of the present disclosure.

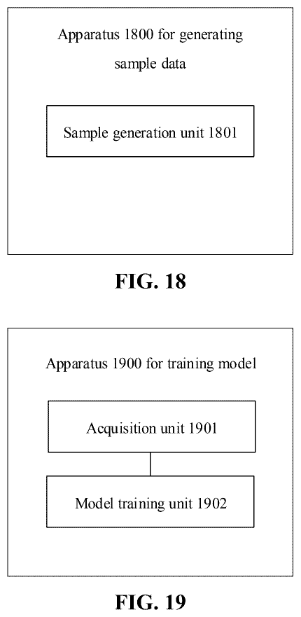

FIG. 18 is a schematic structural composition diagram of an apparatus 1800 for generating sample data according to an embodiment of the present disclosure. As shown in FIG. 18, the apparatus 1800 for generating the sample data includes a sample generation unit 1801.

The sample generation unit 1801 is configured to generate a plurality of pieces of sample data based on a first codebook of a precoding matrix. Here, the plurality of pieces of sample data are used to train an initial channel state information (CSI) feedback model to acquire a CSI feedback meta model, the CSI feedback meta model is used to train a target CSI feedback model, and the CSI feedback model is used to encode channel state information acquired by a signal receiving end, and recover the encoded channel state information at a signal transmitting end.

In an embodiment, the first codebook includes at least one of the following:
a type 1 codebook, a type 2 codebook, or an enhanced type 2 codebook.

In an embodiment, the sample generation unit 1801 is further configured to: select at least one base vector from a vector set corresponding to the first codebook, and generate the plurality of pieces of sample data based on the at least one base vector and a codebook structure of the first codebook.

In an embodiment, the model training apparatus 1800 further includes a generation unit, which is configured to generate the vector set corresponding to the first codebook based on at least one of the number of antenna ports of the signal transmitting end, an oversampling factor, or the number of subbands.

In an embodiment, the plurality of pieces of sample data are formed by D sample data groups, each of the sample data groups corresponds to one task, and each of the sample data groups includes K pieces of sample data, where D and K are integers greater than 1.

In an embodiment, the sample generation unit 1801 is configured to: select a task vector group corresponding to a d-th task from the vector set corresponding to the first codebook, where d is an integer greater than or equal to 1 or less than or equal to D; randomly select at least one base vector from the task vector group corresponding to the d-th task, and generate a k-th piece of sample data of the d-th task based on the codebook structure of the first codebook and the at least one base vector, where k is an integer greater than or equal to 1 or less than or equal to K. Additionally, the sample generation unit 1801 is further configured to: continue to randomly select at least one base vector from the task vector group corresponding to the d-th task, and generate a (k+1)-th piece of sample data of the d-th task based on the codebook structure of the first codebook and the at least one base vector, until K pieces of sample data of the d-th task are acquired; and continue to select a task vector group corresponding to a (d+1)-th task from the vector set corresponding to the first codebook, randomly select at least one base vector from the task vector group corresponding to the (d+1)-th task, and generate K pieces of sample data of the (d+1)-th training task, until K pieces of sample data of each of D tasks are acquired.

In an embodiment, the first codebook is the enhanced type 2 codebook, and the generation unit is further configured to: generate a first vector set based on the number of antenna ports of the signal transmitting end and the oversampling factor; and generate a second vector set based on the number of subbands. Here, the first vector set and the second vector set are included in the vector set.

In an embodiment, an antenna of the signal transmitting end is a two-dimensional planar array antenna, and the sampling factor includes a first sampling factor O₁ and a second sampling factor O₂. Correspondingly, the generation unit is further configured to: generate N₁O₁ first discrete Fourier transform (DFT) vectors based on a first number N₁ of antenna ports of the signal transmitting end in a first dimension and the first sampling factor O1; generate N₂O₂ second DFT vectors based on a second number N₂ of antenna ports of the signal transmitting end in a second dimension and the second sampling factor O₂; and sequentially perform a Kronecker product operation on each of the N₁O₁ first DFT vectors and each of the N₂O₂ second DFT vectors to acquire the first vector set.

In an embodiment, an m-th first DFT vector among the N₁O₁ first DFT vectors is determined through the following operational relationship:

$${v}_{m} = {[ 1 , … , exp ( j 2 π ( x - 1 ) m ) / {N}_{l} {O}_{l} , … , exp ( j 2 π ( {N}_{1} - 1 ) m ) / {N}_{1} {O}_{1} ]}^{T}$$

where m is an integer greater than or equal to 0 or less than or equal to N₁O₁−1, and a value of x ranges from 2 to N₁−1.

Additionally, an n-th second DFT vector among the N₂O₂ second DFT vectors is determined through the following operational relationship:

$${u}_{n} = {[ 1 , … , exp ( j 2 π ( y - 1 ) n ) / {N}_{2} {O}_{2} , … , exp ( j 2 π ( {N}_{2} - 1 ) n ) / {N}_{2} {O}_{2} ]}^{T}$$

where n is an integer greater than or equal to 0 or less than or equal to N₂O₂−1, and a value of y ranges from 2 to N₂−1.

In an embodiment, the number of subbands is Nsb, and the generation unit is further configured to generate an i-th DFT vector in the second vector set according to the following operational relationship, the value of i ranging from 1 to Nsb,

$${q}_{i} = {[ 1 , … , exp ( j 2 π ( 𝓏 - 1 ) i ) / Nsb , … , exp ( j 2 π ( Nsb - 1 ) i ) / Nsb ]}^{T}$$

where a value of z ranges from 1 to Nsb.

In an embodiment, the sample generation unit 1801 is further configured to: randomly select a subset from a plurality of subsets of the first vector set to acquire a target subset, where any two DFT vectors in each of the plurality of subsets are orthogonal to each other; randomly select a plurality of base vectors from the target subset to acquire a first task vector group corresponding to the d-th task; and randomly select a plurality of base vectors from the second vector set to acquire a second task vector group corresponding to the d-th task. Here, the first task vector group and the second task vector group are included in the task vector group corresponding to the d-th task.

In an embodiment, the N₁O₁ first DFT vectors are divided into O₁ first groups, and two adjacent DFT vectors in each first group are separated by O₁ first DFT vectors.

The N₂O₂ second DFT vectors are divided into O₂ second groups, and two adjacent DFT vectors in each second group are separated by O₂ second DFT vectors.

Additionally, the first vector set is divided into O₁*O₂ subsets, and each subset includes N₁*N₂ DFT vectors, where a (q*p)-th subset among the plurality of subsets includes a result of sequentially calculating a Kronecker product of each DFT vector in a q-th first group with each DFT vector in a p-th second group. Here, a is an integer greater than or equal to 1 or less than or equal to O₁, and b is an integer greater than or equal to 1 or less than or equal to O₂.

In an embodiment, the sample generation unit 1801 is further configured to: randomly select at least one first base vector from the first task vector group, and generate a matrix B based on the at least one first base vector; generate a first matrix W₁ in the structure of the first codebook based on the matrix B; select at least one second base vector from the second task vector group, and generate a second matrix W_{f} in the structure of the first codebook based on the at least one second base vector; construct a random number matrix W₂; and generate the k-th piece of sample data of the d-th task based on the first matrix W₁, the second matrix W_{f}, and the random number matrix W₂.

It should be understood by those skilled in the art that the relevant description of the aforementioned apparatus for generating the sample data according to the embodiments of the present disclosure may be understood with reference to the relevant description of the method for generating the sample data according to the embodiments of the present disclosure.

FIG. 19 is a schematic structural composition diagram of an apparatus 1900 for training a model according to an embodiment of the present disclosure. As shown in FIG. 19, the apparatus 1900 for training the model includes an acquisition unit 1901 and a model training unit.

The acquisition unit 1901 is configured to: acquire a channel state information (CSI) feedback meta model, where the CSI feedback meta model is generated based on a first codebook of a precoding matrix; and acquire a plurality of pieces of channel state information. The plurality of pieces of channel state information are acquired via channel estimation based on a channel state information reference signal.

The model training unit 1902 is configured to train the CSI feedback meta model based on the plurality of pieces of channel state information to acquire a target CSI feedback model.

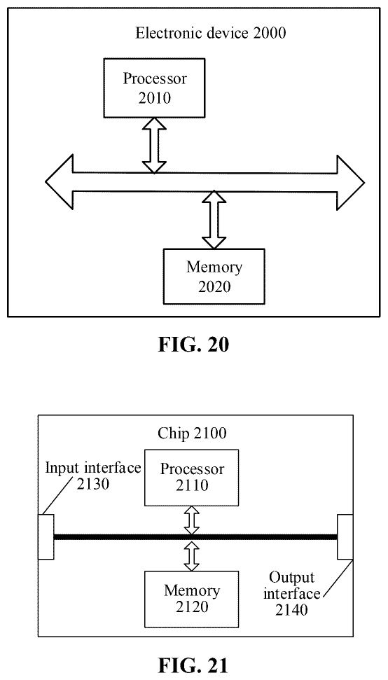

FIG. 20 is a schematic structural diagram of an electronic device 2000 according to an embodiment of the present disclosure. The electronic device may be a first device, a second device, or a third device. The electronic device 2000 shown in FIG. 20 includes a processor 2010, and the processor 2010 may call and run a computer program from a memory to implement the methods in the embodiments of the present disclosure.

In an embodiment, as shown in FIG. 20, the electronic device 2000 may further include a memory 2020. Herein, the processor 2010 may call and run the computer program from the memory 2020 to implement the methods in the embodiments of the present disclosure.

Herein, the memory 1820 may be a separate device independent of the processor 2010, or may be integrated into the processor 2010.

In an embodiment, the electronic device 2000 may specifically be the first device in the embodiments of the present disclosure, and the electronic device 2000 may implement the corresponding processes implemented by the first device in each method of the embodiments of the present disclosure. For brevity, details will not repeated herein again.

In an embodiment, the electronic device 2000 may specifically be the second device in the embodiments of the present disclosure, and the electronic device 2000 may implement the corresponding processes implemented by the second device in each method of the embodiments of the present disclosure. For brevity, details will not repeated herein again.

In an embodiment, the electronic device 2000 may specifically be the third device in the embodiments of the present disclosure, and the electronic device 2000 may implement the corresponding processes implemented by the third device in each method of the embodiments of the present disclosure. For brevity, details will not repeated herein again.

FIG. 21 is a schematic structural diagram of a chip according to an embodiment of the present disclosure. The chip 2100 shown in FIG. 21 includes a processor 2110, and the processor 2110 may call and run a computer program from a memory to implement the methods in the embodiments of the present disclosure.

In an embodiment, as shown in FIG. 21, the chip 2100 may further include a memory 2120. Herein, the processor 2110 may call and run the computer program from the memory 2120 to implement the methods in the embodiments of the present disclosure.

Herein, the memory 2120 may be a separate device independent of the processor 2110, or may be integrated into the processor 2110.

In an embodiment, the chip 2100 may further include an input interface 2130. Herein, the processor 2110 may control the input interface 2130 to communicate with other devices or chips. Specifically, the input interface 2130 may acquire information or data from other devices or chips.

In an embodiment, the chip 2100 may further include an output interface 2140. Herein, the processor 2110 may control the output interface 2140 to communicate with other devices or chips. Specifically, the output interface 2140 may output information or data to other devices or chips.

In an embodiment, the chip may be applied to the first device in the embodiments of the present disclosure, and the chip may implement the corresponding processes implemented by the first device in each method of the embodiments of the present disclosure. For brevity, details will not be repeated herein again.

In an embodiment, the chip may be applied to the second device in the embodiments of the present disclosure, and the chip may implement the corresponding processes implemented by the second device in each method of the embodiments of the present disclosure. For brevity, details will not be repeated herein again.

In an embodiment, the chip may be applied to the third device in the embodiments of the present disclosure, and the chip may implement the corresponding processes implemented by the third device in each method of the embodiments of the present disclosure. For brevity, details will not be repeated herein again.

It should be understood that the chip referred to in the embodiments of the present disclosure may also be referred to as a system-level chip, a system chip, a chip system, or a system-on-chip chip, or the like.

It should be understood that the processor in the embodiments of the present disclosure may be an integrated circuit chip and has a signal processing capability. During an implementation process, various operations in the aforementioned method embodiments may be completed by an integrated logic circuit of hardware or instructions in a software form in the processor. The foregoing processor may be a general-purpose processor, a Digital Signal Processor (DSP), an Application Specific Integrated Circuit (ASIC), a Field Programmable Gate Array (FPGA) or another programmable logical device, discrete gate or transistor logical device, or a discrete hardware component. The various methods, operations, and logical block diagrams disclosed in the embodiments of the present disclosure may be implemented or executed. The general-purpose processor may be a microprocessor, or the processor may also be any conventional processor, etc. The operations of the methods disclosed in combination with the embodiments of the present disclosure may be directly embodied to be executed and completed by a hardware decoding processor, or by a combination of hardware and software modules in the decoding processor. The software module may be located in a mature storage medium in the field, such as a random access memory, a flash memory, a read-only memory, a programmable read-only memory, an electrically erasable programmable memory, a register, or the like. The storage medium is located in a memory, and the processor reads information in the memory to complete the operations of the foregoing methods in combination with the hardware.

It can be understood that the memory in the embodiments of the present disclosure may be a volatile memory or a nonvolatile memory, or may include both the volatile memory and the non-volatile memory. The non-volatile memory may be a Read-Only Memory (ROM), a Programmable ROM (PROM), an Erasable PROM (EPROM), an Electrically EPROM (EEPROM) or a flash memory. The volatile memory may be a Random Access Memory (RAM), which is used as an external high-speed cache. It is exemplarily but unlimitedly described that the RAM in various forms may be adopted, such as a Static RAM (SRAM), a Dynamic RAM, (DRAM), a Synchronous DRAM (SDRAM), a Double Data Rate SDRAM (DDR SDRAM), an Enhanced SDRAM (ESDRAM), a Synchlink DRAM (SLDRAM) and a Direct Rambus RAM (DR RAM). It should be noted that the memory in the systems and methods described herein is intended to include, but is not limited to, the foregoing memory and any other suitable type of memories.

It should be understood that the aforementioned memory is illustrative but not restrictive. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a Direct Rambus RAM (DR RAM), or the like. That is, the memory in the embodiments of the present disclosure is intended to include, but is not limited to, the foregoing memory and any other suitable type of memories.

An embodiment of the present disclosure further provides a computer-readable storage medium configured to store a computer program.

In an embodiment, the computer-readable storage medium may be applied to the first device in the embodiments of the present disclosure, and the computer program is executed to enable a computer to perform the corresponding processes implemented by the first device in each method of the embodiments of the present disclosure. For brevity, details will not be repeated herein again.

In an embodiment, the computer-readable storage medium may be applied to the second device in the embodiments of the present disclosure, and the computer program is executed to enable a computer to perform the corresponding processes implemented by the second device in each method of the embodiments of the present disclosure. For brevity, details will not be repeated herein again.

In an embodiment, the computer-readable storage medium may be applied to the third device in the embodiments of the present disclosure, and the computer program is executed to enable a computer to perform the corresponding processes implemented by the third device in each method of the embodiments of the present disclosure. For brevity, details will not be repeated herein again.

An embodiment of the present disclosure further provides a computer program product, which includes computer program instructions.

In an embodiment, the computer program product may be applied to the first device in the embodiments of the present disclosure, and the computer program instructions are executed to enable a computer to perform the corresponding processes implemented by the first device in each method of the embodiments of the present disclosure. For brevity, details will not be repeated herein again.

In an embodiment, the computer program product may be applied to the second device in the embodiments of the present disclosure, and the computer program instructions are executed to enable a computer to perform the corresponding processes implemented by the second device in each method of the embodiments of the present disclosure. For brevity, details will not be repeated herein again.

In an embodiment, the computer program product may be applied to the third device in the embodiments of the present disclosure, and the computer program instructions are executed to enable a computer to perform the corresponding processes implemented by the third device in each method of the embodiments of the present disclosure. For brevity, details will not be repeated herein again.

An embodiment of the present disclosure further provides a computer program.

In an embodiment, the computer program may be applied to the first device in the embodiments of the present disclosure, and the computer program, when run on a computer, enables the computer to perform the corresponding processes implemented by the first device in each method of the embodiments of the present disclosure. For brevity, details will not be repeated herein again.

In an embodiment, the computer program may be applied to the second device in the embodiments of the present disclosure, and the computer program, when run on a computer, enables the computer to perform the corresponding processes implemented by the second device in each method of the embodiments of the present disclosure. For brevity, details will not be repeated herein again.

In an embodiment, the computer program may be applied to the third device in the embodiments of the present disclosure, and the computer program, when run on a computer, enables the computer to perform the corresponding processes implemented by the third device in each method of the embodiments of the present disclosure. For brevity, details will not be repeated herein again.

Those of ordinary skill in the art may realize that units and algorithm steps of each example described in combination with the embodiments disclosed herein may be implemented by electronic hardware, or a combination of computer software and electronic hardware. Whether these functions are executed in a hardware or software manner depends on specific applications and design constraints of the technical schemes. Professionals may implement the described functions for each specific application by using different methods, but such implementation shall not be regarded as outside the scope of the present disclosure.

Those skilled in the art may clearly understand that, for the specific working processes of the systems, devices and units described above, reference may be made to the corresponding processes in the foregoing method embodiments, and the specific working processes of the systems, devices and units will not be repeated herein for convenient and brief description.

In some embodiments provided by the present disclosure, it should be understood that the disclosed systems, devices, and methods may be implemented in other means. For example, the devices embodiments described above are only illustrative. For example, division of the units is only a kind of logical function division, and other division manners may be adopted during practical implementation. For example, a plurality of units or components may be combined or integrated into another system, or some features may be ignored or not implemented. Furthermore, coupling or direct coupling or communication connection between various displayed or discussed components may be indirect coupling or communication connection, implemented through some interfaces, of the devices or the units, and may be electrical, mechanical, or in other forms.

The units described as separate components may or may not be physically separated, and the components displayed as units may or may not be physical units, that is, they may be located in one place, or may also be distributed to a plurality of network units. Part or all of the units may be selected according to actual needs to achieve the objective of the solution of the present embodiment.

In addition, various functional units in various embodiments of the present disclosure may be integrated into one processing unit, or each functional unit may be physically exist independently, or two or more functional units may be integrated into one unit.

When the functions described above are implemented in the form of a software function module and sold or used as an independent product, the functions may be stored in a computer-readable storage medium. Based onBased on such understanding, the essential part of the technical schemes of the present disclosure or a part of the technical schemes that contributes to the related art or a part of the technical schemes can be embodied in a form of a software product. The computer software product is stored in a storage medium, and includes several instructions to enable a computer device (which may be a personal computer, a server, a network device or the like) to execute all or part of the operations of the methods described in the various embodiments of the present disclosure. The foregoing storage medium includes various media that can store program codes, such as a U disk, a mobile hard disk, a Read Only Memory (ROM), a Random Access Memory (RAM), a magnetic disk, an optical disk, or the like.

The foregoing are only specific implementations of the present disclosure, but the scope of protection of the present disclosure is not limited thereto. Variations or replacements which can be readily thought by those skilled in the art within the technical scope disclosed in the present disclosure shall fall within the scope of protection of the present disclosure. Therefore, the scope of protection of the present disclosure shall be subject to the scope of protection of the claims.

1. A method for training a model, comprising:
generating, by a first device, a plurality of pieces of sample data based on a first codebook of a precoding matrix; and
training, by the first device, an initial channel state information (CSI) feedback model based on the plurality of pieces of sample data to acquire a CSI feedback meta model, wherein the CSI feedback meta model is used to train a target CSI feedback model, and the target CSI feedback model is used to encode channel state information acquired by a signal receiving end, and recover the encoded channel state information at a signal transmitting end.

2. The method of claim 1, wherein the first codebook comprises at least one of the following:
a type 1 codebook, a type 2 codebook, or an enhanced type 2 codebook.

3. The method of claim 1, wherein generating, by the first device, the plurality of pieces of sample data based on the first codebook of the precoding matrix comprises:
selecting, by the first device, at least one base vector from a vector set corresponding to the first codebook, and generating, by the first device, the plurality of pieces of sample data based on the at least one base vector and a codebook structure of the first codebook.

4. The method of claim 3, wherein before selecting, by the first device, the at least one base vector from the vector set corresponding to the first codebook, the method further comprises:
generating, by the first device, the vector set corresponding to the first codebook based on at least one of a number of antenna ports of the signal transmitting end, an oversampling factor, or a number of subbands.

5. The method of claim 1, wherein the plurality of pieces of sample data are formed by D sample data groups, each of the sample data groups corresponds to one task, and each of the sample data group comprises K pieces of sample data, D and K being integers greater than 1.

6. The method of claim 5, wherein generating, by the first device, the plurality of pieces of sample data based on the first codebook of the precoding matrix comprises:
selecting, by the first device, a task vector group corresponding to a d-th task from a vector set corresponding to the first codebook, d being an integer greater than or equal to 1 or less than or equal to D;
randomly selecting, by the first device, at least one base vector from the task vector group corresponding to the d-th task, and generating, by the first device, a k-th piece of sample data of the d-th task based on a codebook structure of the first codebook and the at least one base vector, k being an integer greater than or equal to 1 or less than or equal to K;
continuing, by the first device, to randomly select at least one base vector from the task vector group corresponding to the d-th task, and generating, by the first device, a (k+1)-th piece of sample data of the d-th task based on the codebook structure of the first codebook and the at least one base vector, until K pieces of sample data of the d-th task are acquired; and
continuing, by the first device, to select a task vector group corresponding to a (d+1)-th task from the vector set corresponding to the first codebook, randomly selecting, by the first device, at least one base vector from the task vector group corresponding to the (d+1)-th task, and generating, by the first device, K pieces of sample data of the (d+1)-th training task, until K pieces of sample data of each of D tasks are acquired.

7. The method of claim 6, wherein the first codebook is an enhanced type 2 codebook, and before selecting, by the first device, the task vector group corresponding to the d-th task from the vector set corresponding to the first codebook, the method comprises:
generating, by the first device, a first vector set based on a number of antenna ports of the signal transmitting end and a oversampling factor; and
generating, by the first device, a second vector set based on a number of subbands, wherein the first vector set and the second vector set are comprised in the vector set.

8. The method of claim 7, wherein selecting, by the first device, the task vector group corresponding to the d-th task from the vector set corresponding to the first codebook comprises:
randomly selecting, by the first device, a subset from a plurality of subsets of the first vector set to acquire a target subset, wherein any two DFT vectors in each of the plurality of subsets are orthogonal to each other;
randomly selecting, by the first device, a plurality of base vectors from the target subset to acquire a first task vector group corresponding to the d-th task; and
randomly selecting, by the first device, a plurality of base vectors from the second vector set to acquire a second task vector group corresponding to the d-th task,
wherein the first task vector group and the second task vector group are comprised in the task vector group corresponding to the d-th task.

9. The method of claim 8, wherein randomly selecting the at least one base vector from the task vector group of the d-th task, and generating the k-th piece of sample data of the d-th task based on the codebook structure of the first codebook and the at least one base vector comprises:
randomly selecting at least one first base vector from the first task vector group, and generating a matrix B based on the at least one first base vector;
generating a first matrix W₁ in the structure of the first codebook based on the matrix B;
selecting at least one second base vector from the second task vector group, and generating a second matrix W_{f} in the structure of the first codebook based on the at least one second base vector;
constructing a random number matrix W₂; and
generating the k-th piece of sample data of the d-th task based on the first matrix W₁, the second matrix W_{f}, and the random number matrix W₂.

10. The method of claim 1, wherein training the initial CSI feedback model based on the plurality of pieces of sample data to acquire the CSI feedback meta model comprises:
randomly selecting, by the first device, a sample data group corresponding to one task from the plurality of pieces of sample data, and training, by the first device, the initial CSI feedback model by using a plurality of pieces of sample data in the sample data group to acquire a training weight value of the initial CSI feedback model;
updating, by the first device, the initial CSI feedback model based on the training weight value to acquire an updated initial CSI feedback model; and
continuing, by the first device, to randomly select a sample data group corresponding to one task from the plurality of pieces of sample data, and training, by the first device, the updated initial CSI feedback model by using a plurality of pieces of sample data in the sample data group, until a training ending condition is satisfied to acquire the CSI feedback meta model.

11. An electronic device, comprising:
a memory, and
a processor,
wherein the processor is configured to:
generate a plurality of pieces of sample data based on a first codebook of a precoding matrix; and
train an initial channel state information (CSI) feedback model based on the plurality of pieces of sample data to acquire a CSI feedback meta model, wherein the CSI feedback meta model is used to train a target CSI feedback model, and the target CSI feedback model is used to encode channel state information acquired by a signal receiving end, and recover the encoded channel state information at a signal transmitting end.

12. The electronic device claim 11, wherein the first codebook comprises at least one of the following:
a type 1 codebook, a type 2 codebook, or an enhanced type 2 codebook.

13. The electronic device of claim 11, wherein the processor is further configured to:
select at least one base vector from a vector set corresponding to the first codebook, and generate the plurality of pieces of sample data based on the at least one base vector and a codebook structure of the first codebook.

14. The electronic device of claim 13, wherein before selecting the at least one base vector from the vector set corresponding to the first codebook, the processor is specifically configured to:
generate the vector set corresponding to the first codebook based on at least one of a number of antenna ports of the signal transmitting end, an oversampling factor, or a number of subbands.

15. The electronic device of claim 11, wherein the plurality of pieces of sample data are formed by D sample data groups, each of the sample data groups corresponds to one task, and each of the sample data group comprises K pieces of sample data, D and K being integers greater than 1.

16. The electronic device of claim 15, wherein the processor is further configured to:
select a task vector group corresponding to a d-th task from a vector set corresponding to the first codebook, d being an integer greater than or equal to 1 or less than or equal to D;
randomly select at least one base vector from the task vector group corresponding to the d-th task, and generate a k-th piece of sample data of the d-th task based on a codebook structure of the first codebook and the at least one base vector, k being an integer greater than or equal to 1 or less than or equal to K;
continue to randomly select at least one base vector from the task vector group corresponding to the d-th task, and generate a (k+1)-th piece of sample data of the d-th task based on the codebook structure of the first codebook and the at least one base vector, until K pieces of sample data of the d-th task are acquired; and
continue to select a task vector group corresponding to a (d+1)-th task from the vector set corresponding to the first codebook, randomly select at least one base vector from the task vector group corresponding to the (d+1)-th task, and generate K pieces of sample data of the (d+1)-th training task, until K pieces of sample data of each of D tasks are acquired.

17. The electronic device of claim 16, wherein the first codebook is an enhanced type 2codebook, and before selecting the task vector group corresponding to the d-th task from the vector set corresponding to the first codebook, the processor is specifically configured to:
generate a first vector set based on a number of antenna ports of the signal transmitting end and a oversampling factor; and
generate a second vector set based on a number of subbands,
wherein the first vector set and the second vector set are comprised in the vector set.

18. The electronic device of claim 17, wherein the processor is further configured to:
randomly select a subset from a plurality of subsets of the first vector set to acquire a target subset, wherein any two DFT vectors in each of the plurality of subsets are orthogonal to each other;
randomly select a plurality of base vectors from the target subset to acquire a first task vector group corresponding to the d-th task; and
randomly select a plurality of base vectors from the second vector set to acquire a second task vector group corresponding to the d-th task,
wherein the first task vector group and the second task vector group are comprised in the task vector group corresponding to the d-th task.

19. The electronic device of claim 18, wherein the processor is further configured to:
randomly select at least one first base vector from the first task vector group, and generate a matrix B based on the at least one first base vector;
generate a first matrix W₁ in the structure of the first codebook based on the matrix B;
select at least one second base vector from the second task vector group, and generate a second matrix W_{f} in the structure of the first codebook based on the at least one second base vector;
construct a random number matrix W₂; and
generate the k-th piece of sample data of the d-th task based on the first matrix W₁, the second matrix W_{f}, and the random number matrix W₂.

20. The electronic device of claim 11, wherein the processor is further configured to:
randomly select a sample data group corresponding to one task from the plurality of pieces of sample data, and train the initial CSI feedback model by using a plurality of pieces of sample data in the sample data group to acquire a training weight value of the initial CSI feedback model;
update the initial CSI feedback model based on the training weight value to acquire an updated initial CSI feedback model; and
continue to randomly select a sample data group corresponding to one task from the plurality of pieces of sample data, and train the updated initial CSI feedback model by using a plurality of pieces of sample data in the sample data group, until a training ending condition is satisfied to acquire the CSI feedback meta model.
